(19) United States
(12) Patent Application Publication
(10) Pub. No.: US 2026/0157917 A1
(43) Pub. Date: Jun. 11, 2026

(54) CONTROLLERS DESIGNED FOR MULTI-COMPONENT USE AND APPROACHES TO USING THE SAME TO INFLATE MULTIPLE PRESSURE-MITIGATION APPARATUSES

(71) Applicant: TurnCare, Inc., Palo Alto, CA (US)

(72) Inventor: Rafael Paolo Squitieri, Wilton, CT (US)

(21) Appl. No.: 19/181,872

(22) Filed: Apr. 17, 2025

Related U.S. Application Data
(63) Continuation of application No. PCT/US2023/077417, filed on Oct. 20, 2023.
(60) Provisional application No. 63/380,269, filed on Oct. 20, 2022.

(51) Int. Cl. A61H 9/00; A61G 7/057

(52) U.S. Cl. CPC A61H 9/0092; A61G 7/05769; A61G 2203/10; A61H 2201/0103; A61H 2201/0142; A61H 2201/0173; A61H 2201/1207; A61H 2201/164; A61H 2201/5007; A61H 2201/5058; A61H 2201/5097; A61H 2205/10; A61H 2209/00

(57) ABSTRACT

Introduced here are pressure-mitigation systems (or simply “systems”) that are designed to manage the flow of fluid into pressurizable devices, each of which includes at least one inflatable chamber. A pressure-mitigation system can include a controller device (or simply “controller”) that can be fluidically coupled to pressurizable devices via separate fluid interfaces. Notably, the controller may be able to independently manage the flow of fluid through these fluid interfaces. Accordingly, the controller may cause the chambers of a first pressurizable device to be controllably inflated in accordance with a first programmed pattern and cause the chambers of a second pressurizable device to be controllably inflated in accordance with a second programmed pattern.

### CROSS-REFERENCE TO RELATED APPLICATIONS

This application is a continuation of International Application No. PCT/US2023/077417, titled “Controllers Designed for Multi-Component Use and Approaches to Using the Same to Inflate Multiple Pressure-Mitigation Apparatuses” and filed on Oct. 20, 2023, which claims priority to US Provisional Application No. 63/380,269, titled “Controllers Designed for Multi-Component Use and Approaches to Using the Same to Inflate Multiple Pressure-Mitigation Apparatuses” and filed on Oct. 20, 2022, which are incorporated herein by reference in their entireties.

### TECHNICAL FIELD

Various embodiments concern pressure-mitigation apparatuses able to sequentially or simultaneously alleviate pressure applied to two or more anatomical areas of a living body.

### BACKGROUND

Pressure injuries—sometimes referred to as “decubitus ulcers,” “pressure ulcers,” “pressure sores,” or “bedsores”—may occur as a result of steady pressure being applied in one location along the surface of the human body for a prolonged period of time. Regions with bony prominences are especially susceptible to pressure injuries. Pressure injuries are most common in individuals who are completely immobilized (e.g., on an operating table, bed, or chair) or have impaired mobility. These individuals may be older, malnourished, or incontinent, all factors that predispose the human body to the formation of pressure injuries.

These individuals are often not ambulatory, so they sit or lie for prolonged periods of time in the same position. Moreover, these individuals may be unable to reposition themselves to alleviate pressure. Consequently, pressure on the skin and underlying soft tissue may eventually result in inadequate blood flow to the area, a condition referred to as “ischemia,” thereby resulting in damage to the skin or underlying soft tissue. Pressure injuries can take the form of a superficial injury to the skin or a deeper ulcer that exposes the underlying tissues and places the individual at risk for infection. The resulting infection may worsen, leading to sepsis or even death in some cases.

There are various technologies on the market that profess to prevent injuries caused by prolonged pressure applied to a living body or treat injuries through the mitigation of pressure applied to the living body. However, these conventional technologies have many deficiencies. For instance, these conventional technologies are unable to reliably control the spatial relationship between a human body and a support surface (or simply “surface”) that applies pressure to the human body. Conventional technologies are also unable to effectively coordinate the mitigation of pressure applied to different anatomical regions of the human body. Consequently, individuals who use these conventional technologies have to independently operate multiple devices, with the outcome being that they may still develop pressure injuries or suffer from related complications.

### BRIEF DESCRIPTION OF THE DRAWINGS

FIGS. 1A-B are top and bottom views, respectively, of a pressure-mitigation device able to relieve the pressure on an anatomical region applied by the surface of an elongated object in accordance with embodiments of the present technology.

FIG. 2 is an illustration of a deep vein thrombosis (DVT) compressor in accordance with embodiments of the present technology.

FIG. 3 is an illustration of an intermittent pneumatic compression (IPC) device in accordance with embodiments of the present technology.

FIG. 4 is an illustration of a vital signs monitoring device in accordance with embodiments of the present technology.

FIG. 5 is a partially schematic top view of a pressure-mitigation device illustrating how a pressure gradient can be created by varying pressure distributions to avoid ischemia in a mobility-impaired patient in accordance with embodiments of the present technology.

FIG. 6A is a partially schematic side view of a pressure-mitigation device for relieving pressure on a specific anatomical region by deflating one or more chambers in accordance with embodiments of the present technology.

FIG. 6B is a partially schematic side view of a pressure-mitigation device for relieving pressure on a specific anatomical region by inflating one or more chambers in accordance with embodiments of the present technology.

FIGS. 7A-C are isometric, front, and back views, respectively, of a controller device (also referred to as a “controller”) that is responsible for controlling inflation and/or deflation of the chambers of several pressure-mitigation devices in accordance with embodiments of the present technology.

FIG. 8 illustrates an example of a controller in accordance with embodiments of the present technology.

FIG. 9 is an isometric view of a manifold for controlling the flow of fluid (e.g., air) to the chambers of several pressure-mitigation devices in accordance with embodiments of the present technology.

FIG. 10 is a generalized electrical diagram illustrating how the piezoelectric valves of a manifold can separately control the flow of fluid along multiple channels in accordance with embodiments of the present technology.

FIG. 11 is a flow diagram of a process for varying the pressure in the chambers of two or more pressure-mitigation devices that are attached to or juxtaposed to a human body in accordance with embodiments of the present technology.

FIG. 12 is a partially schematic side view of a pressure-mitigation system (or simply “system”) for a patient (also referred to as a “user”) attached to several pressure-mitigation devices in accordance with embodiments of the present technology.

FIG. 13 is a flow diagram of a process for independently directing fluid flow into each chamber of two or more pressure-mitigation devices that are attached to or juxtaposed to a human body in accordance with embodiments of the present technology.

FIG. 14 is a block diagram illustrating an example of a processing system in which at least some operations described herein can be implemented.

Various features of the technologies described herein will become more apparent to those skilled in the art from a study of the Detailed Description in conjunction with the drawings. Embodiments are illustrated by way of example and not limitation in the drawings. While the drawings depict various embodiments for the purpose of illustration, those skilled in the art will recognize that alternative embodiments may be employed without departing from the principles of the technologies. Accordingly, while specific embodiments are shown in the drawings, the technology is amenable to various modifications.

### DETAILED DESCRIPTION

The term “pressure injury” refers to a localized region of damage to the skin and/or underlying tissue that results from contact pressure (or simply “pressure”) on the corresponding anatomical region of a living body. Pressure injuries will often form over bony prominences, such as the skin and soft tissue overlying the sacrum, coccyx, heels, or hips. However, other sites may also be affected. For instance, pressure injuries may form on the elbows, knees, ankles, shoulders, abdomen, back, or cranium. Pressure injuries may develop when pressure is applied to the blood vessels in soft tissue in such a manner that blood flow to the soft tissue is at least partially obstructed (e.g., due to the pressure exceeding the capillary filling pressure), and ischemia occurs at the site when such obstruction occurs for an extended duration. Accordingly, pressure injuries are normally observed in individuals who are mobility impaired, immobilized, or sedentary for prolonged periods of time.

Once pressure injuries have formed, the healing process is normally slow. When pressure is relieved from the site of a pressure injury, the body will rush blood (with proinflammatory mediators) to that region to perfuse the area with blood. The sudden reperfusion of the damaged (and previously ischemic) region has been shown to cause an inflammatory response, brought on by the proinflammatory mediators, that can actually worsen the pressure injury (and thus prolong recovery). Moreover, in some cases, the proinflammatory mediators may spread through the bloodstream beyond the site of the pressure injury to cause a systematic inflammatory response (also referred to as a “secondary inflammatory response”). Secondary inflammatory responses caused by proinflammatory mediators have been shown to exacerbate existing conditions and/or trigger new conditions, thereby slowing recovery. Recovery can also be prolonged by factors that are frequently associated with individuals who are prone to pressure injuries, such as old age, immobility, preexisting medical conditions (e.g., arteriosclerosis, diabetes, or infection), smoking, and medications (e.g., anti-inflammatory drugs). Inhibiting the formation of pressure injuries (and reducing the prevalence of proinflammatory mediators) can enhance and expedite many treatment processes, especially for those individuals whose mobility is impaired during treatment.

As mentioned above, there are various devices that profess to mitigate pressure applied to living bodies over time. These devices are generally designed for specific anatomical regions. For example, IPC devices include one or more cuffs that are fillable with air, and each cuff is generally designed to surround one of the legs to alleviate pressure applied thereto by an underlying surface—thereby preventing the formation of blood clots in the deep veins of the legs. As another example, several entities have developed mattresses and mattress covers (also called “mattress toppers”) that include one or more chambers that are fillable with air. Generally, these mattresses and mattress toppers have a simple design, often a pair of chambers that are alternately pressurized to shift the pressure applied to a living body in the prone or supine position back and forth between the left and right sides. While these devices may provide effective treatment, there is no way to effectively coordinate their operation. Said another way, there has been no way to coordinate the treatment being provided to different anatomical regions of the same living body. Instead, these devices have been independently operated, not only requiring more effort by operators (e.g., healthcare professionals, such as physicians and nurses) but also resulting in a higher likelihood of improper use or ineffective use.

Introduced here, therefore, are pressure-mitigation systems (or simply “systems”) that are designed to mitigate the pressure applied to a living body by the surface of an object (also referred to as a “structure”). Note that while embodiments are generally described in the context of human bodies, the systems could also be designed and used for mitigating the pressure applied to other living bodies (e.g., animal bodies). As further discussed below, a pressure-mitigation system can include a controller device (or simply “controller”) and a pressure-mitigation device (also referred to as a “pressure-mitigation apparatus” or a “pressure-mitigation pad”) that includes a series of selectively inflatable chambers (also referred to as “cells” or “compartments”). The controller can be fluidically coupled to the pressure-mitigation device. When the pressure-mitigation device is placed between a living body and a surface, the controller can continuously, intelligently, and autonomously circulate fluid through the chambers of the pressure-mitigation device. Normally, the controller circulates air through the chambers of the pressure-mitigation device, though the controller could circulate another fluid, such as water or gel, through the chambers of the pressure-mitigation device. As further discussed below, the controller may cause the chambers to be selectively inflated, deflated, or any combination thereof.

The present disclosure concerns various aspects of systems that comprise at least one pressure-mitigation device and at least one additional item, each with one or more inflatable chambers whose pressure can be regulated by a single controller that independently regulates fluid flow into the at least one pressure-mitigation device and the at least one additional item. Because each of these devices includes at least one inflatable chamber, these devices are capable of being pressurized and, therefore, may be referred to as “pressurizable devices.” Accordingly, the controller may be fluidically coupled to—and responsible for managing fluid flow into—multiple pressurizable devices. These multiple pressurizable devices are generally deployed to apply pressure to, or alleviate pressure from, different anatomical regions of the same living body, though these multiple pressurizable devices could be deployed to apply pressure to, or alleviate pressure from, different living bodies.

In some embodiments, the single controller regulates fluid flow into multiple pressurizable devices in accordance with different pressure schedules and/or timing schedules. These pressurizable devices can be used to manage multiple individuals (also referred to as “patients,” “subjects,” or “users”), or these pressurizable devices can be used to manage a single individual in an attempt to relieve pressure from, or apply pressure to, multiple anatomical regions. These pressurizable devices may be employed in an effort to promote early mobilization to aid in (and expedite) the recovery of injuries affecting different anatomical regions. As further discussed below, these pressurizable devices can be designed for deployment in a home setting, a hospital setting, or both. For example, systems designed for a home setting may include, offer, or support features that might otherwise be provided by equipment accessible in a hospital setting. Likewise, systems designed for a hospital setting may include, offer, or support features that might otherwise be provided by equipment accessible in a home setting. Note that the term “hospital setting” is intended to cover various healthcare environments, including clinics, therapy facilities, surgery facilities, and the like, and not simply hospitals.

As mentioned above, the pressurizable devices could include a pressure-mitigation device and at least one additional item. In some embodiments, the pressure-mitigation device comprises one chamber. In some embodiments, the pressure-mitigation device comprises two chambers. In some embodiments, the pressure-mitigation device comprises three chambers. In some embodiments, the pressure-mitigation device comprises four chambers. In some embodiments, the pressure-mitigation device comprises five chambers. In some embodiments, the pressure-mitigation device comprises six or more chambers. In some embodiments, the at least one additional item comprises one chamber. In some embodiments, the at least one additional item comprises two chambers. In some embodiments, the at least one additional item comprises three chambers. In some embodiments, the at least one additional item comprises four chambers. In some embodiments, the at least one additional item comprises five chambers. In some embodiments, the at least one additional item comprises six or more chambers. In some embodiments, each of the chambers comprises a similar shape and/or a similar size. In some embodiments, each of the chambers comprises a different shape and/or a different size. In some embodiments, the fluid flow into each of the one or more chambers of the pressure-mitigation device or the additional item is different. In some embodiments, the chamber comprises an L shape, an M shape, or a C shape. In some embodiments, the chamber comprises a circular shape. In some embodiments, the chamber comprises an elongated shape. In some embodiments, the chamber comprises a square shape. In some embodiments, the chamber comprises an annular shape. In some embodiments, the chamber comprises a cylindrical shape. In some embodiments, the chamber comprises an asymmetric shape. In some embodiments, the chamber comprises a symmetric shape. In some embodiments, the chamber comprises an irregular shape.

As mentioned above, in some embodiments of the system, each of the at least one pressure-mitigation device and the at least one additional item has one or more inflatable chambers whose pressure can be individually varied in a controlled manner. In some embodiments, the pressure to each of the at least one pressure-mitigation device and the at least one additional item is varied in a controlled manner at different times and with different fluid flow. The one or more inflatable chambers of a first pressure-mitigation device can be designed and arranged so as to apply a physical force on a first anatomical region (e.g., the sacral region) with the first pressure-mitigation device. For example, the inflatable chambers may be intertwined around an epicenter in a geometric pattern based on the internal anatomy of the first anatomical region to which the pressure-mitigation device is targeted. When the inflatable chambers of the first pressure-mitigation device are pressurized in accordance with the programmed (e.g., in terms of time and pressure) pattern executed by the controller, a body-surface interaction is produced that emulates the interactions seen in healthy (e.g., mobile) individuals. However, instead of the patient periodically moving herself away from the surface to adjust contact pressure applied by the surface, the first pressure-mitigation device shifts the patient. Accordingly, the first pressure-mitigation device, in conjunction with the controller, can mimic the micro-adjustments that healthy individuals regularly make. This creates a scenario in which an individual can remain partially or entirely motionless for an extended period of time, yet physiologically the net pressure effect on the individual is roughly the same as if the individual had maintained more natural motion (e.g., performed micro-adjustments). Such an approach prevents prolonged tissue compression, which can lead to ischemia and reperfusion injuries that result in lasting tissue damage (e.g., ulcers) and other adverse systemic health consequences.

Additionally, in some embodiments of the system, the one or more inflatable chambers of an additional item or a second pressure-mitigation device can be designed and arranged so as to apply pressure to, or relieve pressure from, a second anatomical region (e.g., the right lower leg) with the additional item or the second pressure-mitigation device. In some embodiments, the system comprises a first pressure-mitigation device designed and arranged to apply a physical force on a first anatomical region and a second pressure-mitigation device designed and arranged to apply a physical force on a second anatomical region, wherein the first pressure-mitigation device and the second pressure-mitigation device are attached to one controller. In some embodiments, the applying a physical force comprises facilitating alignment. In some embodiments, the applying a physical force comprises mitigating pressure. In some embodiments, the applying the physical force comprises facilitating movement. In some embodiments, the applying a physical force comprises applying pressure.

In some embodiments, a third pressure-mitigation device can be designed and arranged so as to apply a physical force on a third anatomical region (e.g., the left lower leg) with the third pressure-mitigation device. In some embodiments, the system comprises a first pressure-mitigation device designed and arranged to apply a physical force on a first anatomical region, a second pressure-mitigation device designed and arranged to apply a physical force on a second anatomical region, and a third pressure-mitigation device designed and arranged to apply a physical force on a third anatomical region, wherein the first pressure-mitigation device, the second pressure-mitigation device, and the third pressure-mitigation device are attached to one controller.

In some embodiments, the system comprises a first pressure-mitigation device designed and arranged to apply a physical force on a first anatomical region, a second pressure-mitigation device designed and arranged to apply a physical force on a second anatomical region, a third pressure-mitigation device designed and arranged to apply a physical force on a third anatomical region, and a fourth pressure-mitigation device designed and arranged to apply a physical force on a fourth anatomical region, wherein the first pressure-mitigation device, the second pressure-mitigation device, the third pressure-mitigation device, and the fourth pressure-mitigation device are attached to one controller. In some embodiments, the system comprises five or more pressure-mitigation devices, each targeting a distinct anatomical region, wherein all of the five or more pressure-mitigation devices are attached to a single controller.

Accordingly, the controller may be operable to independently control the flow of fluid (e.g., air) into any number of pressurizable devices. To accomplish this, the controller may alter, for each pressurizable device, a corresponding fluid flow in accordance with a programmed pattern corresponding to that pressurizable device. In some embodiments, the controller directs a first fluid flow into a first pressurizable device, a second fluid flow into a second pressurizable device, a third fluid flow into a third pressurizable device, and subsequent fluid flows into subsequent pressurizable devices. In some embodiments, the first fluid flow, second fluid flow, third fluid flow, and subsequent fluid flows are each independently constant or variable. In some embodiments, the first fluid flow, second fluid flow, third fluid flow, and subsequent fluid flows are each independently continuous or interrupted. In some embodiments, the first fluid flow, second fluid flow, third fluid flow, and subsequent fluid flows are each independently initiated and completed at the same or at different times.

In some embodiments of the system, the system comprises one or more pressure-mitigation devices and one or more additional items, wherein the fluid flow into each of the one or more pressure-mitigation devices and each of the one or more additional items is independently directed by a controller, wherein one controller independently directs fluid flow into each of the one or more pressure-mitigation devices and each of the one or more additional items. In some embodiments, the one or more pressure-mitigation devices and the one or more additional items are attached to a single patient. In some embodiments, the one or more pressure-mitigation devices and the one or more additional items are attached to two or more patients.

In some embodiments of the system, the system comprises a first pressurizable device that is selected from the group consisting of: an alignment-facilitating device, a deep vein thrombosis (DVT) compressor, neonatal heels, an intermittent pneumatic compression (IPC) device, a TABS-fall monitoring device, a vital signs monitoring device, a negative pressure wound vacuum therapy (NPWT) device, a patient boost system (also called a “patient lifter system”), and a heel pressure injury prevention wedge. In some embodiments, the IPC device is Venodyne® boots. In some embodiments, the alignment-facilitating device facilitates alignment of one or more anatomical areas of a patient. In some embodiments of the system, the system comprises a first pressure-mitigation device that is a DVT compressor designed and arranged to apply physical force on a first anatomical region that is a leg. In some embodiments, the system comprises a second pressure-mitigation device that is neonatal heels designed and arranged to apply a physical force on a second anatomical region that comprises heels. In some embodiments, the system comprises a third pressure-mitigation device that is an IPC device designed and arranged to apply a physical force on a third anatomical region that comprises lower legs. In some embodiments, the system comprises a fourth pressure-mitigation device that is a TABS-fall monitoring device designed and arranged to facilitate monitoring of whether a patient is leaving a surface, wherein the TABS-fall monitoring device is attached to a fourth anatomical region that comprises an arm and/or a leg. In some embodiments, the system comprises a fifth pressure-mitigation device that is a vital signs monitoring device designed and arranged to facilitate patient motion tracking and/or predictive analysis, wherein the vital signs monitoring device is attached to a fifth anatomical region that comprises an arm and/or a leg. In some embodiments, the system comprises a sixth pressure-mitigation device that is an NPWT device designed and arranged to reduce and/or prevent the occurrence of bed sores and/or other wounds, wherein the NPWT device is attached to a sixth anatomical region that comprises a sacral area. In some embodiments, the system comprises a seventh pressure-mitigation device that is a patient boost system designed and arranged to facilitate facile repositioning of a patient, wherein the patient boost system is attached to a seventh anatomical region that comprises a lower back area, and wherein the patient boost system is optionally built into an inflatable alignment-facilitating device. In some embodiments, the inflatable enhancer is a handle. In some embodiments, the system comprises an eighth pressure-mitigation device that is a heel pressure injury prevention wedge designed and arranged to reduce and/or prevent the occurrence of heel injuries, wherein the heel pressure injury prevention wedge is attached to an eighth anatomical region that comprises a foot, ankle, and/or lower leg area.

By controllably varying the pressure in one or more chambers of a pressure-mitigation device and/or an additional item, the controller can move the main point of pressure applied by the surface to different regions across the human body. For example, the controller may cause the main point of pressure applied by the surface to be moved among a plurality of predetermined anatomic locations by sequentially varying the level of inflation of (and pressure in) predetermined subsets of chambers. Such an approach results in pressure gradients being created across the human body. In some embodiments, the controller controls the pressure of chambers located beneath specific anatomic locations for specific durations in order to move point(s) of pressure applied by the underlying surface around the anatomy in a precise manner such that specific portions of the anatomy (e.g., the tissue adjacent to bony prominences) do not experience direct pressure for an extended duration. The relocation of the pressure point(s) avoids vascular compression for sustained periods of time, inhibits ischemia, and reduces the incidence of pressure injuries. In some embodiments, the fluid flow into each of the one or more chambers of the pressure-mitigation device or the additional item is simultaneous. In some embodiments, the fluid flow into each of the one or more chambers of the pressure-mitigation device or the additional item is not simultaneous. In some embodiments, the fluid flow into each of the one or more chambers of the pressure-mitigation device or the additional item is the same.

In some embodiments, the controller is attached to a first pressure-mitigation device and a second pressure-mitigation device, wherein the controller is programmed to differentially inflate and deflate each pressure chamber in each pressure-mitigation device. In some embodiments, the controller is attached to a first pressure-mitigation device, a second pressure-mitigation device, and a third pressure-mitigation device, wherein the controller is programmed to differentially inflate and deflate each pressure chamber in each pressure-mitigation device. In some embodiments, the controller is attached to a first pressure-mitigation device, a second pressure-mitigation device, a third pressure-mitigation device, and a fourth pressure-mitigation device, wherein the controller is programmed to differentially inflate and deflate each pressure chamber in each pressure-mitigation device. In some embodiments, the controller is attached to a first pressure-mitigation device, a second pressure-mitigation device, a third pressure-mitigation device, a fourth pressure-mitigation device, and a fifth pressure-mitigation device, wherein the controller is programmed to differentially inflate and deflate each pressure chamber in each pressure-mitigation device. In some embodiments, the controller is attached to a first pressure-mitigation device, a second pressure-mitigation device, a third pressure-mitigation device, a fourth pressure-mitigation device, a fifth pressure-mitigation device, and a sixth pressure-mitigation device, wherein the controller is programmed to differentially inflate and deflate each pressure chamber in each pressure-mitigation device. In some embodiments, the controller is attached to a first pressure-mitigation device, a second pressure-mitigation device, a third pressure-mitigation device, a fourth pressure-mitigation device, a fifth pressure-mitigation device, a sixth pressure-mitigation device, and a seventh pressure-mitigation device, wherein the controller is programmed to differentially inflate and deflate each pressure chamber in each pressure-mitigation device. Accordingly, the controller could be attached to more than one pressure-mitigation device, and the controller may independently inflate each pressure-mitigation device in accordance with a different programmed pattern.

In some embodiments, each pressure-mitigation device is attached to the controller via one or more tubes. In some embodiments, the one or more tubes are hollow tubes. As an example, each chamber of a given pressure-mitigation device could be associated with a different tube. Similarly, each chamber of the given pressure-mitigation device could be associated with a different channel of multi-channel tubing, as further discussed below.

Such an approach to mitigating pressure is useful in various contexts.

Assume, for example, that an individual has been identified as a candidate for treatment after entering a hospital. In such a scenario, a medical professional may obtain a portable system comprised of two or more pressure-mitigation devices and a controller. Examples of medical professionals include doctors, nurses, therapists, and the like. The medical professional can deploy the two or more pressure-mitigation devices on two or more surfaces on which the individual is to be immobilized, either partially or entirely, and then orient the individual on top of the two or more pressure-mitigation devices. Thereafter, the medical professional can cause the portable system to shift a point of pressure applied by each surface to the individual by pressurizing the inflatable chambers of the corresponding pressure-mitigation device to varying degrees in accordance with a programmed pattern. For example, the medical professional may initiate pressurization of the inflatable chambers by indicating that treatment should begin via the controller.

As another example, assume that an individual has been instructed to utilize two or more pressure-mitigation devices as part of a treatment regimen (e.g., following discharge from a hospital). In such a scenario, the individual may be provided with a portable system comprised of two or more pressure-mitigation devices and a controller. When the individual reaches her home, she can deploy the two or more pressure-mitigation devices on one or more surfaces on which she is to be immobilized. For example, the individual may insert each of her legs in a separate IPC device in order to alleviate pressure applied by a single underlying surface, or the individual may insert one of her legs in an IPC device while situating an alignment-facilitating device in order to alleviate pressure applied by a single surface (e.g., a bed) or multiple surfaces (e.g., a bed and incline board or wedge positioned beneath her leg).

As a specific example, assume that the individual arranges each pressure-mitigation device on a chair or bed, as further discussed below. After the individual arranges herself on top of the two or more pressure-mitigation devices, she can cause the portable system to shift a point of pressure applied by the surfaces to her body by pressurizing the inflatable chambers of the pressure-mitigation devices to varying degrees in accordance with a programmed pattern. Thus, the controller may be able to access one or more programmed patterns associated with a first pressure-mitigation device, one or more programmed patterns associated with a second pressure-mitigation device, etc. These programmed patterns could be stored in the memory of the controller, or these programmed patterns could be stored in a storage medium that is accessible to the controller (e.g., via the Internet). In another example, the individual may arrange each pressure-mitigation device such that one pressure-mitigation device mitigates the pressure applied by another pressure-mitigation device or such that one pressure-mitigation device does not mitigate the pressure applied by another pressure-mitigation device. In some embodiments, two or more pressure-mitigation devices could alleviate pressure applied by a single surface. In some embodiments, two or more pressure-mitigation devices could alleviate pressure applied by two or more surfaces. Those skilled in the art will recognize that a similar process may be performed if the portable device is provided to, or deployed by, a caretaker, such as a family member or friend.

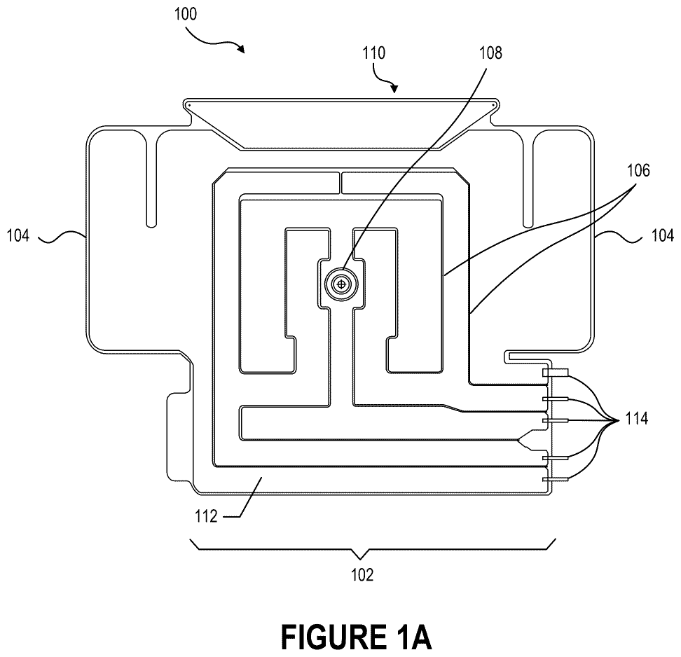

Embodiments may be described with reference to particular pressurizable devices, anatomical regions, treatment regimens, environments, etc. However, those skilled in the art will recognize that the features are similarly applicable to other pressurizable devices, anatomical regions, treatment regimens, environments, etc. As an example, embodiments may be described in the context of multiple pressure-mitigation devices that are positioned adjacent to different anatomical regions of the individual. However, aspects of those embodiments may apply to a controller that manages fluid flow into a single pressure-mitigation device and another pressurizable device or multiple pressurizable devices. Embodiments may be described in the context of pressure-mitigation devices for the purpose of illustration only, as pressure-mitigation devices and methods of operation are discussed in greater detail with reference to FIGS. 1A-B, 5-6B, and 8-10.

While embodiments may be described in the context of machine-readable instructions, aspects of the technology can be implemented via hardware, firmware, or software. As an example, a controller may not only execute instructions for determining an appropriate rate at which to permit fluid (e.g., air) flow into the inflatable chamber of a pressure-mitigation device but may also be responsible for facilitating communication with other computing devices. For example, the controller may be able to communicate with a mobile device that is associated with the individual or a caregiver, or the controller may be able to communicate with a computer server of a network-accessible server system.

### Terminology

References in this description to “an embodiment” or “one embodiment” mean that the feature, function, structure, or characteristic being described is included in at least one embodiment of the technology. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense (i.e., in the sense of “including but not limited to”). The term “based on” is also to be construed in an inclusive sense rather than an exclusive or exhaustive sense. Thus, unless otherwise noted, the term “based on” is intended to mean “based at least in part on.”

The terms “connected,” “coupled,” and variants thereof are intended to include any connection or coupling between two or more elements, either direct or indirect. The connection/coupling can be physical, logical, or a combination thereof. For example, objects may be electrically or communicatively coupled to one another despite not sharing a physical connection.

The term “module” may refer to software components, firmware components, or hardware components. Modules are typically functional components that generate one or more outputs based on one or more inputs. As an example, a computer program may include multiple modules responsible for completing different tasks or a single module responsible for completing all tasks.

When used in reference to a list of multiple items, the term “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open ended.

### Overview of Pressure-Mitigation Devices

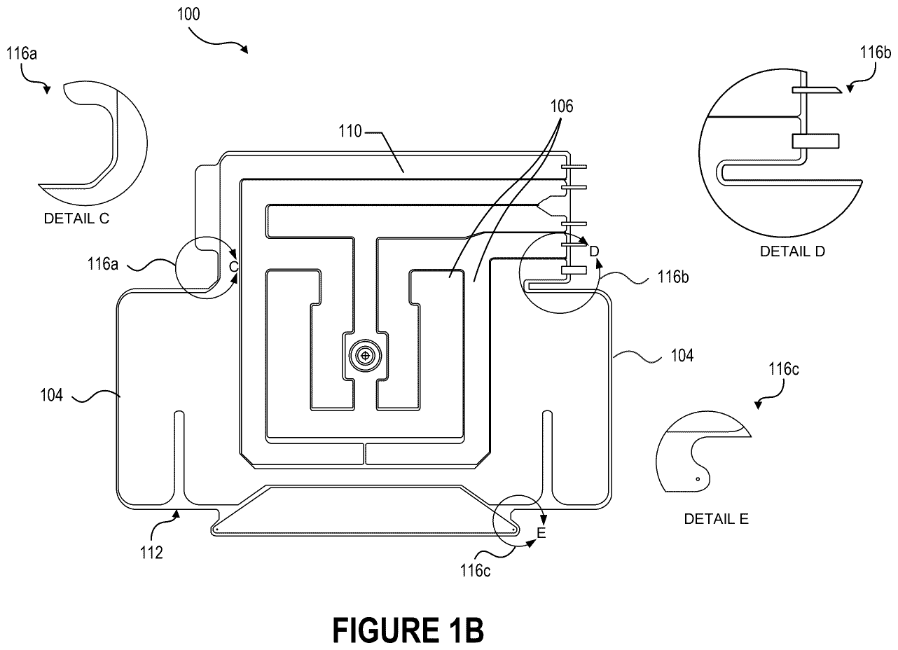

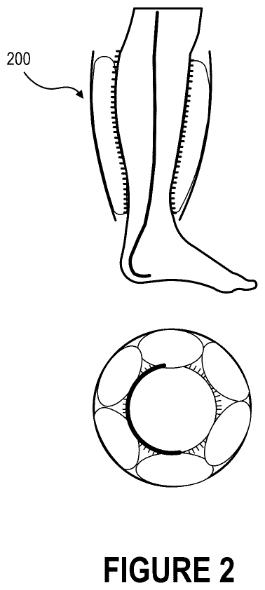

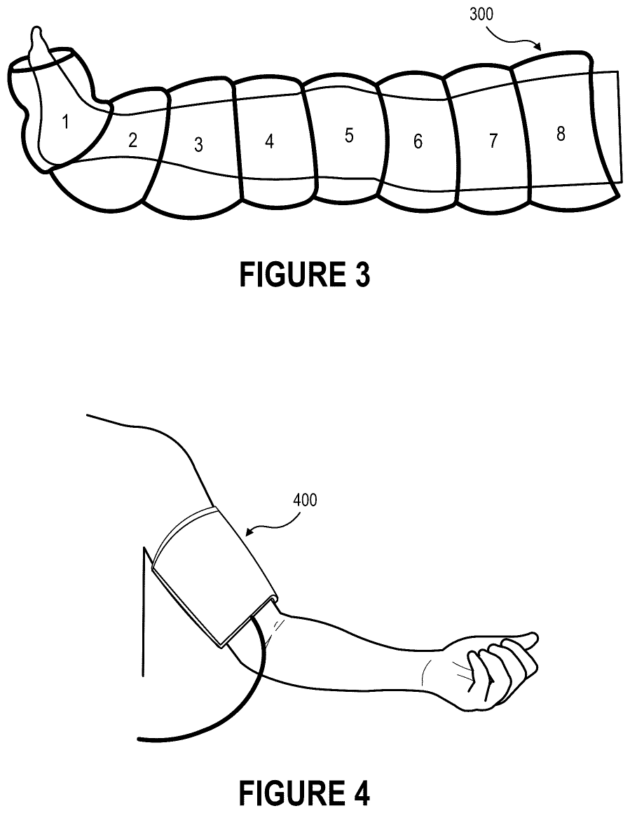

A pressure-mitigation device may include one or more chambers (also referred to as “cells” or “compartments”) into which fluid or air can flow. Some pressure-mitigation devices include a single chamber, while other pressure-mitigation devices include a plurality of chambers. Each chamber may be associated with a discrete flow of air so that the pressure can be varied as necessary. FIGS. 1A-1B illustrate an example of a pressure-mitigation device—referred to as an “alignment-facilitating device”—that includes a plurality of chambers, wherein the pressure of each of the chambers can be independently varied. FIGS. 2, 3, and 4 illustrate examples of other pressure-mitigation devices: a DVT compressor (FIG. 2), an IPC device (FIG. 3), and a vital signs monitor (FIG. 4). Unless otherwise noted, any features described with respect to one embodiment are equally applicable to other embodiments. Some features have been described only with respect to a single embodiment for the purpose of simplifying the present disclosure.

FIGS. 1A-B are top and bottom views, respectively, of an example of a pressure-mitigation device, such as an alignment-facilitating device 100, able to relieve the pressure on an anatomical region applied by the surface of an elongated object in accordance with embodiments of the present technology. While the pressure-mitigation device 100 may be described in the context of elongated objects, such as mattresses, stretchers, operating tables, and procedure tables, the pressure-mitigation device 100 could be deployed on non-elongated objects. In some embodiments, the pressure-mitigation device 100 is secured to a support surface using an attachment apparatus. In other embodiments, the pressure-mitigation device 100 is placed in direct contact with the surface without any attachment apparatus therebetween. For example, the pressure-mitigation device 100 may have a tacky substance deposited along at least a portion of its outer surface that allows it to temporarily adhere to the surface. Examples of tacky substances include latex, urethane, and silicone rubber.

As shown in FIG. 1A, the pressure-mitigation device 100 can include a central portion 102 (also referred to as a “contact portion”) that is positioned alongside at least one side support 104. Here, a pair of side supports 104 are arranged on opposing sides of the central portion 102. However, some embodiments of the pressure-mitigation device 100 do not include any side supports. For example, the side support(s) 104 may be omitted when the individual is medically immobilized (e.g., under anesthesia, in a medically induced coma, etc.) and/or physically restrained by an underlying object (e.g., by rails along the side of a bed, armrests along the side of a chair, etc.) or some other structure (e.g., physical restraints, casts, etc.).

The pressure-mitigation device 100 includes a series of chambers 106 whose pressure can be individually varied. In some embodiments, the series of chambers 106 are arranged in a geometric pattern designed to relieve pressure on specific anatomical region(s) of a human body. As noted above, when placed between the human body and a surface, the pressure-mitigation device 100 can vary the pressure on these specific anatomical region(s) by controllably inflating and/or deflating chamber(s).

In some embodiments, the series of chambers 106 are arranged such that pressure on a given anatomical region is mitigated when the given anatomical region is oriented over a target region 108 of the geometric pattern. As shown in FIGS. 1A-B, the target region 108 may be representative of a central point of the pressure-mitigation device 100 to appropriately position the anatomy of the human body with respect to the pressure-mitigation device 100. For example, the target region 108 may correspond to an epicenter of the geometric pattern. However, the target region 108 may not necessarily be the central point of the pressure-mitigation device 100, particularly if the series of chambers 106 are positioned in a non-symmetric arrangement. The target region 108 may be visibly marked so that an individual can readily align the target region 108 with a corresponding anatomical region of the human body to be positioned thereon. Thus, the pressure-mitigation device 100 may include a visual element representative of the target region 108 to facilitate alignment with the corresponding anatomical region of the human body. The individual could be a physician, nurse, caregiver, or the patient.

The pressure-mitigation device 100 can include a first portion 110 (also referred to as a “first layer” or “bottom layer”) designed to face a surface and a second portion 112 (also referred to as a “second layer” or “top layer”) designed to face the human body supported by the surface. In some embodiments, the pressure-mitigation device 100 is deployed such that the first portion 110 is directly adjacent to the surface. For example, the first portion 110 may have a tacky substance deposited along at least a portion of its exterior surface that facilitates temporary adhesion to the support surface. In other embodiments, the pressure-mitigation device 100 is deployed such that the first portion 110 is directly adjacent to an attachment apparatus designed to help secure the pressure-mitigation device 100 to the support surface. The pressure-mitigation device 100 may be constructed of various materials, and the material(s) used in the construction of each component of the pressure-mitigation device 100 may be chosen based on the nature of the body contact, if any, to be experienced by the component. For example, because the second portion 112 will often be in direct contact with the skin, it may be comprised of a soft fabric or a breathable fabric (e.g., comprised of moisture-wicking materials or quick-drying materials, or having perforations). In some embodiments, an impervious lining (e.g., comprised of polyurethane) is secured to the inside of the second portion 112 to inhibit fluid (e.g., sweat) from entering the series of chambers 106. As another example, if the pressure-mitigation device 100 is designed for deployment beneath a cover (e.g., a bed sheet), then the second portion 112 may be comprised of a flexible, liquid-impervious material, such as polyurethane, polypropylene, silicone, or rubber. The first portion 110 may also be comprised of a flexible, liquid-impervious material.

Generally, the first and second portions 110, 112 are selected and/or designed such that the pressure-mitigation device 100 is readily cleanable. However, the specific materials that are used may vary depending on the environment in which the pressure-mitigation device 100 is to be deployed. Assume, for example, that the pressure-mitigation device 100 is intended to be deployed in a hospital environment. In such a scenario, the first and second portions 110, 112 may be readily cleanable with a cleaning agent (e.g., bleach) or a cleaning procedure (e.g., sterilization). Because the pressure-mitigation device 100 will remain in the hospital environment under the care of knowledgeable persons, the first and second portions 110, 112 could be comprised of materials that may degrade quickly if not properly cared for. Examples of such materials include high-performance fabric, upholstery, vinyl, and other suitable textiles. If the pressure-mitigation device 100 is instead intended to be deployed in a home environment, the first and second portions 110, 112 may be comprised of materials that can be readily cleaned by persons without extensive experience. For example, the first portion 110 and/or the second portion 112 may be comprised of a vinyl that is easy to clean with commonly available cleaning agents (e.g., bleach, liquid dish soap, all-purpose cleaners). Regardless of the environment, the first and second portions 110, 112 may contain antimicrobial additives, antifungal additives, flame-retardant additives, and the like.

The series of chambers 106 may be formed via interconnections between the first and second portions 110, 112. For example, the first and second portions 110, 112 may be bound directly to one another, or the first and second portions 110, 112 may be bound to one another via one or more intermediary layers. In the embodiment illustrated in FIGS. 1A-B, the pressure-mitigation device 100 includes an “M-shaped” chamber intertwined with two “C-shaped” chambers that face one another. Such an arrangement has been shown to effectively mitigate the pressure applied to the sacral region of a human body in the supine position by a support surface when the pressure in these chambers is alternated. The series of chambers 106 may be arranged differently if the pressure-mitigation device 100 is designed for an anatomical region other than the sacral region or if the pressure-mitigation device 100 is to be used to support a human body in a non-supine position (e.g., a prone position or sitting position). Generally, the geometric pattern of chambers 106 is designed based on the internal anatomy (e.g., the muscles, bones, and vasculature) of the anatomical region on which pressure is to be relieved.

The person using the pressure-mitigation device 100 and/or the caregiver (e.g., a nurse, physician, family member, etc.) may be responsible for actively orienting the anatomical region of the human body lengthwise over the target region 108 of the geometric pattern. If the pressure-mitigation device 100 includes one or more side supports 104, the side support(s) 104 may actively orient or guide the anatomical region of the human body laterally over the target region 108 of the geometric pattern. In some embodiments, the side support(s) 104 are inflatable, while in other embodiments, the side support(s) 104 are permanent structures that protrude from one or both lateral sides of the pressure-mitigation device 100. For example, at least a portion of each side support may be stuffed with cotton, latex, polyurethane foam, or any combination thereof.

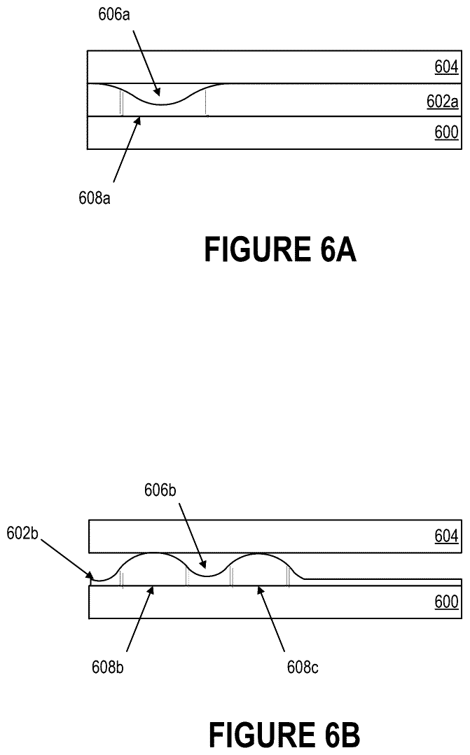

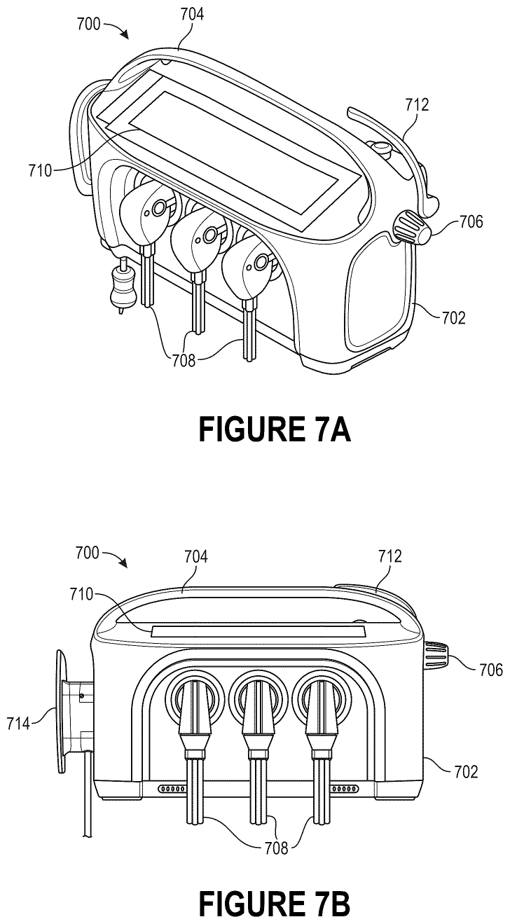

As further described below with respect to FIGS. 6A-C, a controller can separately or independently control the pressure in each chamber (as well as the side supports 104 if included) by providing a discrete airflow via one or more corresponding valves 114. In some embodiments, the valves 114 are permanently secured to the pressure-mitigation device 100 and designed to interface with tubing that can be readily detached (e.g., for easier transport, storage, etc.). Here, the pressure-mitigation device 100 includes five valves 114. Three valves are fluidically coupled to the series of chambers 106, and two valves are fluidically coupled to the side supports 104. Other embodiments of the pressure-mitigation device 100 may include more than five valves or less than five valves. For example, the pressure-mitigation device 100 may be designed such that a pair of side supports 104 are pressurized via a single airflow received via a single valve.

In some embodiments, the pressure-mitigation device 100 includes one or more design features 116a-c designed to facilitate securement of the pressure-mitigation device 100 to the surface of an object and/or an attachment apparatus. As illustrated in FIG. 1B, for example, the pressure-mitigation device 100 may include three design features 116a-c, each of which can be aligned with a corresponding structural feature that is accessible along the surface of the object or the attachment apparatus. For example, each design feature 116a-c may be designed to at least partially envelop a structural feature that protrudes upward. One example of such a structural feature is a rail that extends along the side of a bed. The design feature(s) 116a-c may also facilitate proper alignment of the pressure-mitigation device 100 with the surface of the object or the attachment apparatus.

While not shown in FIGS. 1A-B, one or more release valves (also referred to as “discharge valves”) may be located along the periphery of the pressure-mitigation device 100 to allow for quick discharge of the fluid stored therein. Normally, the release valve(s) are located along the longitudinal sides to ensure that the release valve(s) are not located beneath a human body situated on the pressure-mitigation device 100. Release valve(s) may allow discharge of fluid from the side supports 104 and/or the series of chambers 106. In some embodiments, fluid is separately or collectively dischargeable from the side supports 104 (e.g., where each side support has at least one release valve). Such a design is desirable in some scenarios because fluid can quickly be discharged from the side supports 104, which allows the human body situated on the pressure-mitigation device 100 to be accessed (e.g., in the case of a medical emergency). In other embodiments, fluid is only collectively dischargeable from the side supports 104. This approach to “dually deflating” the side supports 104 may be taken if release valve(s) are connected to only one side support, though both side supports are fluidically coupled to one another. The release valve(s) may be manually or electrically actuated. For example, the release valve(s) may be manually actuated by pressing a mechanical button (also referred to as a “strike button”) that, when pressed, allows fluid to flow out of the corresponding chamber or side support. In embodiments where the fluid is air, the air may be permitted to flow into the ambient environment. In embodiments where the fluid is water or gel, the fluid may be directed into a container (e.g., from which the fluid can then be rerouted through the controller as further discussed below). As another example, the release valve(s) may be electronically actuated by interacting with a switch assembly (e.g., located along the exterior surface of the pressure-mitigation device 100), a controller, or another computing device (e.g., a mobile phone or wearable electronic device) that is communicatively connected to the pressure-mitigation device 100.

FIG. 2 is an illustration of a pressurizable device that is an example of a deep vein thrombosis (DVT) compressor 200. A DVT compressor with multiple chambers is shown, where each chamber is juxtaposed to a surface of a patient's leg. In some embodiments, a DVT compressor is applied to a different anatomical region of a patient. In some embodiments, a DVT compressor is applied to an arm or a leg of a patient. In some embodiments, a DVT compressor is applied to two or more anatomical regions of a patient. In some embodiments, a DVT compressor is applied to an arm and a leg of a patient or both arms of a patient or both legs of a patient.

FIG. 3 is an illustration of a pressurizable device that is an example of an intermittent pneumatic compression (IPC) device 300. An IPC device with multiple chambers is shown, where each chamber is juxtaposed to a surface of a patient's leg. In some embodiments, an IPC device is applied to a different anatomical region of a patient. In some embodiments, an IPC device is applied to an arm or a leg of a patient. In some embodiments, an IPC device is applied to two or more anatomical regions of a patient. In some embodiments, an IPC device is applied to an arm and a leg of a patient or both arms of a patient or both legs of a patient.

FIG. 4 is an illustration of a pressurizable device that is an example of a vital signs monitoring device 400. A vital signs monitoring device with at least one chamber is shown, where the at least one chamber is juxtaposed to a surface of a patient's arm. In some embodiments, a vital signs monitoring device is applied to a different anatomical region of a patient. In some embodiments, a vital signs monitoring device is applied to two or more anatomical regions of a patient.

### Overview of Approaches to Mitigating Pressure

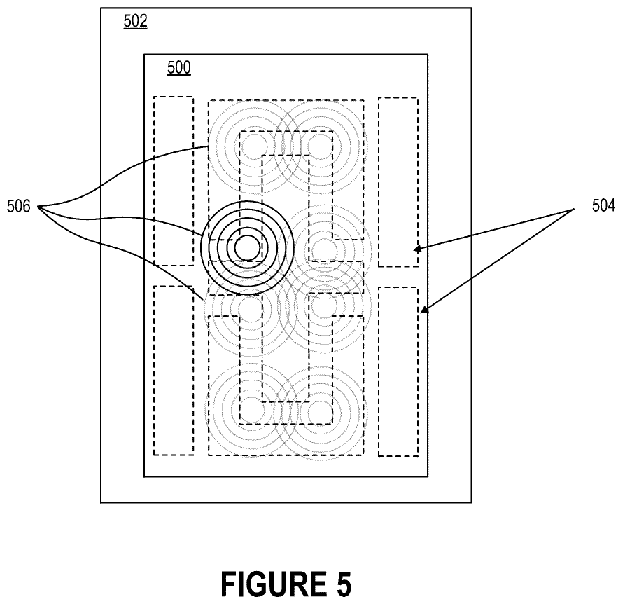

FIG. 5 is a partially schematic top view of a pressure-mitigation device, such as a pressure-mitigation device 500, illustrating how a pressure gradient can be created by varying pressure distributions to avoid ischemia in a mobility-impaired patient in accordance with embodiments of the present technology. When a human body is supported by a surface 502 for an extended duration, pressure injuries may form in the tissue overlaying bony prominences, such as the skin overlying the sacrum, coccyx, heels, or hips. Generally, these bony prominences represent the locations at which the most pressure is applied by the surface 502 and, therefore, may be referred to as the “main pressure points” along the surface of the human body.

To prevent the formation of pressure injuries, healthy individuals periodically make minor positional adjustments (also known as “micro-adjustments”) to shift the location of the main pressure point. However, individuals having impaired mobility often cannot make these micro-adjustments by themselves. Mobility impairment may be due to physical injury (e.g., a traumatic injury or a progressive injury), movement limitations (e.g., within a vehicle, on an aircraft, or in restraints), medical procedures (e.g., those requiring anesthesia), and/or other conditions that limit natural movement. For these mobility-impaired individuals, the pressure-mitigation device 500 can be used to shift the location of the main pressure point(s) on their behalf. That is, the pressure-mitigation device 500 can create moving pressure gradients to avoid sustained, localized vascular compression and enhance tissue perfusion.

The pressure-mitigation device 500 can include a series of chambers 504 whose pressure can be individually varied. The chambers 504 may be formed by interconnections between the top and bottom layers of the pressure-mitigation device 500. The top layer may be comprised of a first material (e.g., a permeable, non-irritating material) configured for direct contact with a human body, while the bottom layer may be comprised of a second material (e.g., a non-permeable, gripping material) configured for direct contact with the surface 502. Generally, the first material is permeable to gasses (e.g., air) and/or liquids (e.g., water and sweat) to prevent buildup of fluids that may irritate the skin. Meanwhile, the second material may not be permeable to gasses or liquids to prevent soilage of the underlying object. Accordingly, air discharged into the chambers 504 may be able to slowly escape through the first material (e.g., naturally or via perforations) but not the second material, while liquids may be able to penetrate the first material (e.g., naturally or via perforations) but not the second material. Note, however, that the first material is generally selected such that the top layer does not actually become saturated with liquid to reduce the likelihood of irritation. Instead, the top layer may allow liquid to pass therethrough into the cavities, from which the liquid can be subsequently discharged (e.g., as part of a cleaning process). The top layer and/or the bottom layer can be comprised of more than one material, such as a coated fabric or a stack of interconnected materials.

The pressure-mitigation device 500 may be designed such that inflation of at least some of the chambers 504 causes air to be continuously exchanged across the surface of the human body. Said another way, simultaneous inflation of at least some of the chambers 504 may provide a desiccating effect to inhibit generation and/or collection of moisture along the skin in a given anatomical region. In some embodiments, the pressure-mitigation device 500 is able to maintain airflow through the use of a porous material. For example, the top layer may be comprised of a biocompatible material through which air can flow (e.g., naturally or via perforations). In other embodiments, the pressure-mitigation device 500 is able to maintain airflow without the use of a porous material. For example, airflows can be created and/or permitted simply through varied pressurization of the chambers 504. This represents a new approach to microclimate management that is enabled by simultaneous inflation and deflation of the chambers 504. At a high level, each void formed beneath a human body due to deflation of at least one chamber can be thought of as a microclimate that cools and desiccates the corresponding portion of the anatomical region. Heat and humidity can lead to injury (e.g., further development of ulcers), so the cooling and desiccating effects may present some injuries due to inhibition of moisture generation/collection along the skin in the anatomical region.

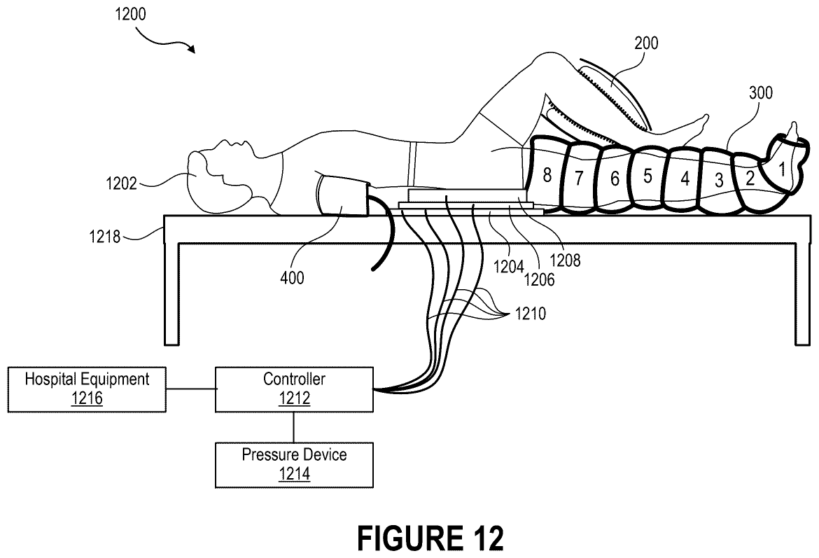

As discussed below with respect to FIG. 12, a pump (also referred to as a “pressure device”) can be fluidically coupled to each chamber 504 (e.g., via a corresponding valve) of each pressure-mitigation device, while a controller can control the flow of fluid generated by the pump into each chamber 504 on an individual basis in accordance with a predetermined pattern. The controller can operate the series of chambers 504 in several different ways.

In some embodiments, the chambers 504 have a naturally deflated state, and the controller causes the pump to inflate at least one of the chambers 504 to shift the main pressure point along the anatomy of the human body. For example, the pump may inflate at least one chamber located directly beneath an anatomical region to momentarily apply contact pressure to that anatomical region and relieve contact pressure on the surrounding anatomical regions adjacent to the deflated chamber(s). Alternatively, the controller may cause the pump to inflate two or more chambers adjacent to an anatomical region to create a void beneath the anatomical region to shift the main pressure point at least momentarily away from the anatomical region.

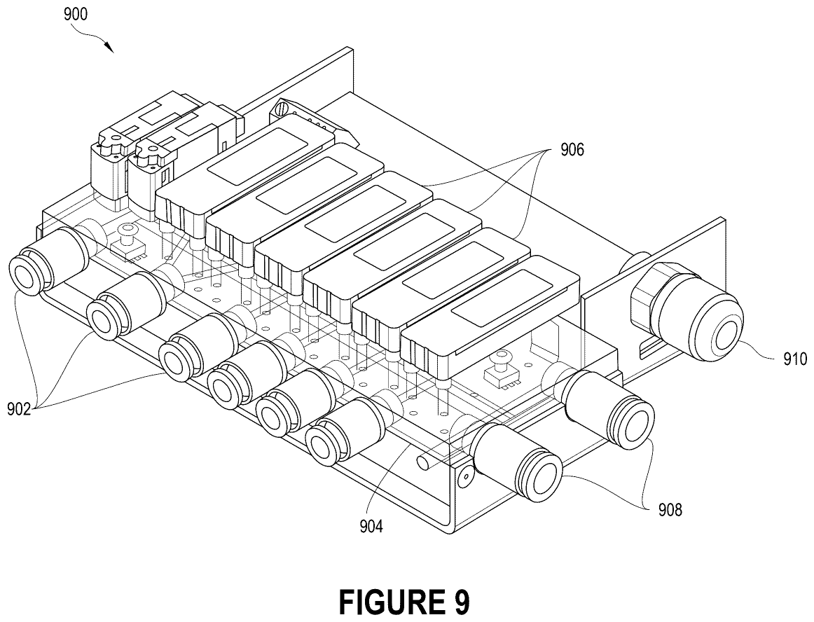

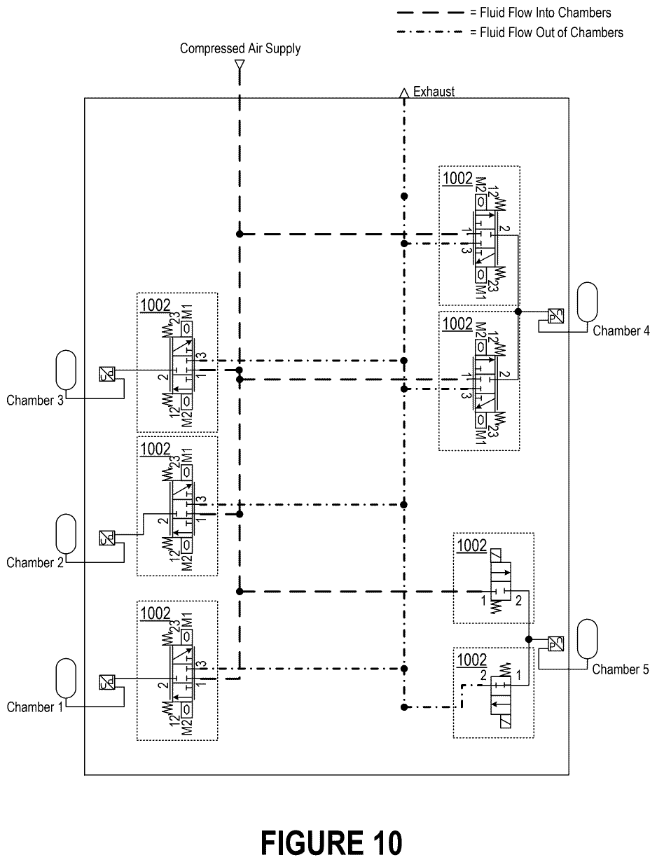

In other embodiments, the chambers 504 have a naturally inflated state, and the controller may cause deflation of at least one of the chambers 504 to shift the main pressure point along the anatomy of the human body. For example, the pump may cause deflation of at least one chamber located directly beneath an anatomical region, thereby forming a void beneath the anatomical region to momentarily relieve the contact pressure on the anatomical region. To deflate a chamber, the controller may simply prevent an airflow generated by the pump from entering the chamber, as further discussed below with reference to FIGS. 9-10. Additionally or alternatively, the controller may cause air contained in the chamber to be released (e.g., via a valve). At least partial deflation may naturally occur in this scenario if air escapes through the valve quicker than air enters the chamber.

Whether configured in a naturally deflated state or a naturally inflated state, the continuous or intermittent alteration of the inflation levels of the individual chambers 504 moves the location of the main pressure point across different portions of the human body. As shown in FIG. 5, for example, inflating and/or deflating the chambers 504 creates temporary contact regions 506 that move across the pressure-mitigation device 500 in a predetermined pattern, thereby changing the location of the main pressure point(s) on the human body for finite intervals of time. Thus, the pressure-mitigation device 500 can simulate the micro-adjustments made by healthy individuals to relieve stagnant pressure applied by the surface 502.

The series of chambers 504 may be arranged in an anatomy-specific pattern so that when the pressure of one or more chambers is altered, the contact pressure on a specific anatomical region of the human body is relieved (e.g., by shifting the main pressure point elsewhere). As an example, the main pressure point may be moved between eight different locations corresponding to the eight temporary contact regions 506, as shown in FIG. 5. In some embodiments, the main pressure point shifts between these locations in a predictable manner (e.g., in a clockwise or counterclockwise pattern), while in other embodiments, the main pressure point shifts between these locations in an unpredictable manner (e.g., in accordance with a random pattern or a semi-random pattern based on the amount of force applied by the human body to the chambers or based on the pressure of the chambers). Those skilled in the art will recognize that the number and position of these temporary contact regions 506 may vary based on the size of the pressure-mitigation device 500, the arrangement of chambers 504, the number of chambers 504, the anatomical region supported by the pressure-mitigation device 500, the characteristics of the human body supported by the pressure-mitigation device 500, the condition of the human body (e.g., whether the person is completely immobilized, partially immobilized, etc.), or any combination thereof.

As discussed above, the pressure-mitigation device 500 may not include side supports if the condition of a user (also referred to as the “patient” or “subject”) would not benefit from the positioning assistance provided by the side supports. For example, side supports can be omitted when the user is medically immobilized (e.g., under anesthesia, in a medically induced coma, etc.) and/or physically restrained on the underlying surface 502 (e.g., by rails on the side of a bed, arm rests on the side of a chair, restraints that limit movement, etc.).

FIG. 6A is a partially schematic side view of a pressure-mitigation device 602a for relieving pressure on a specific anatomical region by deflating one or more chambers in accordance with embodiments of the present technology. The pressure-mitigation device 602a can be positioned between the surface of an object 600 and a human body 604. Examples of objects 600 include elongated objects, such as mattresses, stretchers, operating tables, and procedure tables, and non-elongated objects, such as chairs (e.g., office chairs, examination chairs, recliners, and wheelchairs) and the seats included in vehicles and airplanes. To relieve the pressure on a specific anatomical region of the human body 604, at least one chamber 608a of multiple chambers (collectively referred to as “chambers 608”) proximate to the specific anatomical region is at least partially deflated to create a void 606a beneath the specific anatomical region. In such embodiments, the remaining chambers 608 may remain inflated. Thus, the pressure-mitigation device 602a may sequentially deflate chambers (or arrangements of multiple chambers) to relieve the pressure applied to the human body 604 by the surface of the object 600.

FIG. 6B is a partially schematic side view of a pressure-mitigation device 602b for relieving pressure on a specific anatomical region by inflating one or more chambers in accordance with embodiments of the present technology. For example, to relieve the pressure on a specific anatomical region of the human body 604, the pressure-mitigation device 602b can inflate two chambers 608b and 608c disposed directly adjacent to the specific anatomical region to create a void 606b beneath the specific anatomical region. In such embodiments, the remaining chambers may remain partially or entirely deflated. Thus, the pressure-mitigation device 602b may sequentially inflate a chamber (or arrangements of multiple chambers) to relieve the pressure applied to the human body 604 by the surface of the object 600.

The pressure-mitigation devices 602a, 602b of FIGS. 6A-B are shown to be in direct contact with the surface of the object 600. However, in some embodiments, an attachment apparatus is positioned between the pressure-mitigation devices 602a, 602b and the object 600. The attachment apparatus may be designed to help secure the pressure-mitigation devices 602a, 602b and the object 600. For example, the attachment apparatus may be made of a material that is naturally tacky or sticky so as to inhibit movement of the pressure-mitigation devices 602a, 602b with respect to the object 600. Alternatively, the bottom side of the pressure-mitigation devices 602a, 602b could be coated with a material, such as a removable adhesive (e.g., an elastomer-or silicone-based sealant or a pressure-sensitive film) or tacky substance (e.g., silicone rubber).

In some embodiments, the pressure-mitigation devices 602a, 602b of FIGS. 6A-B have the same configuration of chambers 608 and can operate in both a normally inflated state (described with respect to FIG. 6A) and a normally deflated state (described with respect to FIG. 6B) based on the selection of an operator (e.g., the user or some other person, such as a medical professional or family member). For example, the operator can use a controller to select a normally deflated mode such that the pressure-mitigation device operates as described with respect to FIG. 6B and then change the mode of operation to a normally inflated mode such that the pressure-mitigation device operates as described with respect to FIG. 6A. Thus, the pressure-mitigation devices described herein can shift the location of the main pressure point by controllably inflating chambers, controllably deflating chambers, or a combination thereof.

### Overview of Controller Devices

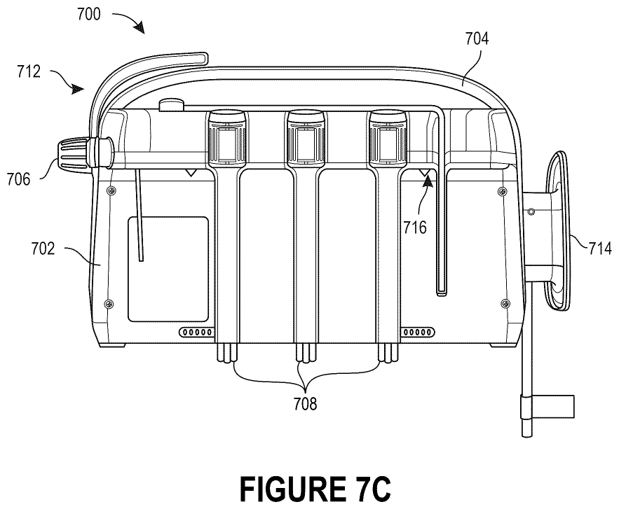

FIGS. 7A-C are isometric, front, and back views, respectively, of a controller device 700 (also referred to as a “controller”) that is responsible for controlling inflation and/or deflation of the chambers of two or more pressurizable devices in accordance with embodiments of the present technology. For example, the controller 700 can be coupled to two or more pressurizable devices 100, 200, 300, 400 described above with respect to FIGS. 1A-4 to control the pressure within the chambers. The controller 700 can manage the pressure in each chamber of the two or more pressurizable devices by controllably driving one or more pumps. In some embodiments, a single pump is fluidically connected, via the controller 700, to all the chambers of the two or more pressurizable devices such that the pump is responsible for generating the fluid flow to be directed to and/or from multiple chambers. In other embodiments, the controller 700 is coupled to two or more pumps, each of which can be fluidically coupled to a single chamber to drive inflation/deflation of that chamber. In other embodiments, the controller 700 is coupled to at least one pump that is fluidically coupled to two or more chambers and/or at least one pump that is fluidically coupled to a single chamber. The pump(s) may reside within the housing of the controller 700 such that the system is easily transportable. Alternatively, the pump(s) may reside in a housing separate from the controller 700.

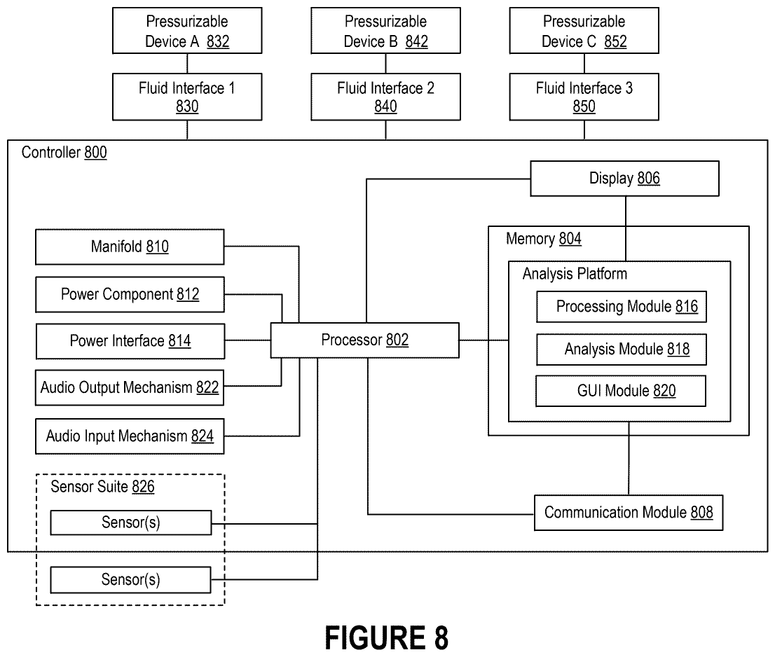

As shown in FIGS. 7A-C, the controller 700 can include a housing 702 in which internal components (e.g., those described below with respect to FIG. 8) reside and a handle 704 that is connected to the housing 702. In some embodiments, the handle 704 is fixedly secured to the housing 702 in a predetermined orientation, while in other embodiments, the handle 704 is pivotably secured to the housing 702. For example, the handle 704 may be rotatable about a hinge connected to the housing 702 between multiple positions. The hinge may be one of a pair of hinges connected to the housing 702 along opposing lateral sides. The handle 704 enables the controller 700 to be readily transported, for example, from a storage location to a deployment location (e.g., proximate to a human body that is positioned on a surface). Moreover, the handle 704 could be used to releasably attach the controller 700 to a structure. For example, the handle 704 could be hooked on an intravenous (IV) pole (also referred to as an “IV stand” or “infusion stand”).

In some embodiments, the controller 700 includes a retention mechanism 714 that is attached to, or integrated within, the housing 702. Cords (e.g., electrical cords), tubes, and/or other elongated structures associated with the system can be wrapped around or otherwise supported by the retention mechanism 714. Thus, the retention mechanism 714 may provide strain relief and retention of an electrical cord (also referred to as a “power cord”). In some embodiments, the retention mechanism 714 includes a flexible flange that can retain the plug of the electrical cord.

As further shown in FIGS. 7A-C, the controller 700 may include a connection mechanism 712 that allows the housing 702 to be securely, yet releasably, attached to a structure. Examples of structures include IV poles, mobile workstations (also referred to as “mobile carts”), bedframes, rails, handles (e.g., of wheelchairs), and tables. The connection mechanism 712 may be used instead of, or in addition to, the handle 704 for mounting the controller 700 to the structure. In the illustrated embodiment, the connection mechanism 712 is a mounting hook that allows for single-hand operation and is adjustable to allow for attachment to mounting surfaces with various thicknesses. In some embodiments, the controller 700 includes an IV pole clamp 716 that eases attachment of the controller 700 to IV poles. The IV pole clamp 716 may be designed to enable quick securement, and the IV pole clamp 716 can be self-centering with the use of a single activation mechanism (e.g., knob or button).

In some embodiments, the housing 702 includes one or more input components 706 for providing instructions to the controller 700. The input component(s) 706 may include knobs (e.g., as shown in FIGS. 7A-C), dials, buttons, levers, and/or other actuation mechanisms. An operator can interact with the input component(s) 706 to alter the airflow provided to the two or more pressurizable devices, discharge air from the pressurizable devices, or disconnect the controller 700 from the two or more pressurizable devices (e.g., by disconnecting the controller 700 from tubing connected between the controller 700 and the two or more pressurizable devices).

As further discussed below, the controller 700 can be configured to independently inflate and/or deflate one or more chambers of two or more pressurizable devices in a predetermined pattern specific for each pressurizable device by managing one or more flows of fluid (e.g., air) produced by one or more pumps. In some embodiments, the pump(s) reside in the housing 702 of the controller 700, while in other embodiments, the controller 700 is fluidically connected to the pump(s). For example, the housing 702 may include a first fluid interface through which fluid is received from the pump(s) and a second fluid interface through which fluid is directed to the two or more pressurizable devices. Multi-channel tubing may be connected to either of these fluid interfaces. For example, multi-channel tubing may be connected between the first fluid interface of the controller 700 and multiple pumps. As another example, multi-channel tubing may be connected between the second fluid interface of the controller 700 and multiple valves of the two or more pressurizable devices. Here, the controller 700 includes two or more fluid interfaces 708 designed to interface with multi-channel tubing. In some embodiments, the multi-channel tubing permits unidirectional fluid flow, while in other embodiments, the multi-channel tubing permits bidirectional fluid flow. Thus, fluid returning from each of the two or more pressurizable devices (e.g., as part of a discharge process) may travel back to the controller 700 through the second fluid interface. By controlling the exhaust of fluid returning from each of the two or more pressurizable devices, the controller 700 can actively manage the noise created during use.

By monitoring the connections with the fluid interfaces 708, the controller 700 may be able to detect which types of pressurizable devices have been connected. Each type of pressurizable device may include a different type of connector. For example, a pressure-mitigation device designed for elongated objects (e.g., the pressure-mitigation device 100 of FIGS. 1A-B) may include a first arrangement of magnets in its connector, while a pressure-mitigation device designed for non-elongated objects may include a second arrangement of magnets in its connector. The controller 700 may include one or more sensors arranged near the fluid interfaces 708 that are able to detect whether magnets are located within a specified proximity. The controller 700 may automatically determine, based on which magnets have been detected by the sensor(s), which types of pressurizable devices are connected. As another example, a vital signs monitoring device may be fluidically coupled to one of the fluid interfaces 708 via single-or dual-channel tubing, whereas a pressure-mitigation apparatus may be fluidically coupled to one of the fluid interfaces 708 via multi-channel tubing having at least three channels through which fluid is able to flow toward a corresponding chamber. The controller 700 may be able to automatically determine which types of pressurizable devices are connected thereto simply by monitoring the fluid interfaces 708 (e.g., to identify, for each fluid interface, how many channels are being occupied). Additionally or alternatively, the controller 700 may monitor other connections proximate to the fluid interfaces 708. For example, some pressurizable devices may be fluidically connected to the fluid interfaces 708 via cabling that includes one or more fluid channels, as well as one or more power channels or one or more data channels. Some pressurizable devices may be identifiable simply through the presence of these power channels or data channels, while other pressurizable devices may be identifiable based on the number or combination of the fluid channels, power channels, or data channels. In the event that a data channel exists, the controller 700 could also receive, via the data channel, an input that is indicative of an identification of the type of pressurizable device. Thus, the pressurizable device might indicate, to the controller 700, its type upon establishing a connection thereto. As further discussed below with reference to FIG. 8, this input could also be received by the controller 700 at its communication module 808.

Pressurizable devices may have different geometries, layouts, and/or dimensions suitable for various positions (e.g., supine, prone, sitting), various supporting objects (e.g., wheelchair, bed, recliner, surgical table), and/or various user characteristics (e.g., weight, size, ailment), and the controller 700 can be configured to automatically detect the types of pressurizable devices connected thereto. In some embodiments, the automatic detection is performed using other suitable identification mechanisms, such as the controller 700 reading a radio-frequency identification (RFID) tag or barcode on the pressurizable devices. Alternatively, the controller 700 may permit an operator to specify the types of pressurizable devices connected thereto. For example, the operator may be able to select, using an input component (e.g., input component 706), a type of pressurizable device via a display 710. The controller 700 can be configured to dynamically and independently alter the pattern for inflating and/or deflating chambers based on which types of pressurizable devices are connected.

As shown in FIGS. 7A-B, the controller 700 may include a display 710 for displaying information related to the two or more pressurizable devices, the pattern of inflations/deflations, the user, etc. For example, the display 710 may present an interface that specifies which types of pressurizable devices are connected to the controller 700. As another example, the display 710 may present an interface that specifies the programmable pattern that is presently governing inflation/deflation of the pressurizable devices, as well as the current state within the programmable patterns for each pressurizable device. Other display technologies could also be used to convey information to an operator of the controller 700. In some embodiments, the controller 700 includes a series of lights (e.g., light-emitting diodes) that are representative of different statuses to provide visual alerts to the operator or the user. For example, a status light may provide a green visual indication if the controller 700 is presently providing therapy, a yellow visual indication if the controller 700 has been paused (i.e., is in a pause mode), a red visual indication if the controller 700 has experienced an issue (e.g., noncompliance of patient, patient not detected) or requires maintenance (i.e., is in an alert mode), etc. These visual indications may dim upon the conclusion of a specified period of time or upon determining that the status has changed (e.g., the pause mode is no longer active).

In some embodiments, the controller 700 includes a rapid deflate function that allows an operator to rapidly and independently deflate each of the two or more pressurizable devices. The rapid deflate function may be designed such that the entirety of a pressurizable device is deflated or a portion (e.g., the side supports of a pressure-mitigation device) of the pressurizable device is deflated. This may be a software-implemented solution that can be activated via the display 710 (e.g., when configured as a touch-enabled interface) and/or input components (e.g., tactile actuators such as buttons, switches, etc.) on the controller 700. This rapid deflation, in particular, the deflation of the side supports, is expected to be beneficial to operators when there is a need for quick access to the user, such as to provide cardiopulmonary resuscitation (CPR).

FIG. 8 illustrates an example of a controller 800 in accordance with embodiments of the present technology. As shown in FIG. 8, the controller 800 can include a processor 802, memory 804, display 806, communication module 808, manifold 810, and/or power component 812 that is electrically coupled to a power interface 814. These components may reside within a housing (also referred to as a “structural body”), such as the housing 702 described above with respect to FIGS. 7A-C. In some embodiments, the aspects of the controller 800 are incorporated into other components of a pressure-mitigation system. For example, some components of the controller 800 may be incorporated into a computing device (e.g., a mobile phone or a mobile workstation) that is remotely coupled to two or more pressurizable devices. FIG. 8 illustrates an example of a controller 800 independently directing fluid flow into two or more pressure-mitigation devices, in the case illustrated, three pressurizable devices, namely Device A 832, Device B 842, and Device C 852. In the example illustrated, the controller 800 independently directs fluid flow into each pressurizable device via a fluid interface, in the case illustrated, fluid interface 1 830 to Device A 832, fluid interface 2 840 to Device B 842, and fluid interface 3 850 to Device C 852.

Each of these components is discussed in greater detail below. Those skilled in the art will recognize that different combinations of these components may be present depending on the nature of the controller 800. Other components could also be included depending on the desired capabilities of the controller 800.

For example, the controller could include one or more fragrance output mechanisms (e.g., spray pumps or spray nozzles) that are able to discharge scented fluid (e.g., air or liquid) from corresponding reservoirs so as to produce an aroma. Such a feature may be desirable if one of the two or more pressurizable devices is intended to be used as part of a therapy program.

As another example, the controller could include a circuitry that is able to detect and then examine electronic signatures emitted by nearby beacons. Accordingly, if an item (e.g., a wristband or file) that includes a beacon is presented to the controller, the controller may be able to detect the electronic signature emitted by the beacon and then take appropriate action. For instance, the controller may determine, based on the electronic signature that conveys information regarding the human body to be treated, how to independently inflate each of the chambers of the two or more pressurizable devices. Electronic signatures may be transmitted via RFID, Bluetooth, Near Field Communication (NFC), or another short-range wireless communication protocol. Additionally or alternatively, the controller may be able to examine machine-readable codes (e.g., Quick Response codes, bar codes, and alphanumeric strings) that are printed on items such as wristbands, files, and the like. By examining the machine-readable code that is printed on an item associated with a human body, the controller may be able to determine, infer, or derive information regarding the human body. These features allow a controller to act as a “single action” solution for treating the human body since the controller may automatically begin treatment after an electronic signature or machine-readable code has been presented.

The processor 802 can have generic characteristics similar to general-purpose processors, or the processor 802 may be an application-specific integrated circuit (ASIC) that provides control functions to the controller 800. As shown in FIG. 8, the processor 802 can be coupled to all components of the controller 800, either directly or indirectly, for communication purposes.

The memory 804 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 802, the memory 804 can also store data generated by the processor 802 (e.g., when executing the analysis platform). Note that the memory 804 is merely an abstract representation of a storage environment. The memory 804 could be comprised of actual memory chips or modules.

The display 806 can be any mechanism that is operable to visually convey information to an operator. For example, the display 806 may be a panel that includes LEDs, organic LEDs, liquid crystal elements, or electrophoretic elements, as shown in FIGS. 7A-B. Alternatively, the display 806 may simply be a series of lights (e.g., LEDs) that are able to indicate the status of the controller 800. In some embodiments, the display 806 is touch sensitive. Thus, an operator or user may be able to provide input to the controller 800 by interacting with the display 806 itself. Additionally or alternatively, the operator may be able to provide input to the controller 800 by interacting with input components, such as knobs, dials, buttons, levers, and/or other actuation mechanisms.

The communication module 808 may be responsible for managing communications between the components of the controller 800, or the communication module 808 may be responsible for managing communications with other computing devices (e.g., a mobile phone associated with the operator, a network-accessible server system accessible to an entity responsible for manufacturing, providing, or managing pressure-mitigation devices). The communication module 808 may be wireless communication circuitry that is designed to establish communication channels with other computing devices. Examples of wireless communication circuitry include integrated circuits (also referred to as “chips”) configured for Bluetooth, Wi-Fi, NFC, and the like.

Moreover, the communication module 808 may be responsible for providing information for uploading to, and retrieving information from, the electronic health record that is associated with the human body that is presently being treated. Assume, for example, that the controller 800 receives input indicating that a given person is to be treated using two or more pressurizable devices. In such a situation, the controller 800 may establish a connection with a storage medium that includes the electronic health record of the given person. In some embodiments, the controller 800 downloads information from the electronic health record into the memory 804, while in other embodiments, the controller 800 simply accesses the information in the electronic health record. This information could be used to determine how to treat the given person. For example, the controller may determine, based on the weight and age of the given person, which patterns to select for inflating each of the chambers of the two or more pressurizable devices, whether and when to adjust the patterns, etc.

The controller 800 may be connected to two or more pressure-mitigation devices that each include a series of chambers whose pressure can be individually varied. When each pressure-mitigation device is placed between a human body and the surface of an object, the controller 800 can independently cause the pressure on an anatomical region of the human body to be varied by controllably inflating and/or deflating chamber(s). Such action can be accomplished by the manifold 810, which controls the flow of fluid to the series of chambers of each pressure-mitigation device. The manifold 810 is further described with respect to FIGS. 9-10.

As further discussed below, transducers mounted in the manifold 810 can generate an electrical signal based on the pressure detected in each chamber of each pressurizable device. Generally, each chamber is associated with a different fluid channel and a different transducer. Accordingly, if the manifold 810 is designed to facilitate the flow of fluid to a pressurizable device with four chambers, the manifold 810 may include four fluid channels and four transducers. In some embodiments, the manifold 810 includes fewer than four fluid channels and/or transducers or more than four fluid channels and/or transducers. Pressure data representative of the values of the electrical signals generated by the transducers can be stored, at least temporarily, in the memory 804. As further discussed below, the manifold 810 may be driven based on a clock signal that is generated by a clock module (not shown). For example, the processor 802 may be configured to generate signals for driving valves in the manifold 810 (or driving integrated circuits in communication with the valves) based on a comparison of the clock signal to programmed patterns that indicate when each chamber of the two or more pressurizable devices should be independently inflated or deflated. The programmed patterns may belong to a set of multiple programmed patterns that are stored in the memory 804.

An analysis platform may be responsible for examining the pressure data. For convenience, the analysis platform is described as a computer program that resides in the memory 804. However, the analysis platform could be comprised of software, firmware, or hardware that is implemented in, or accessible to, the controller 800. In accordance with embodiments described herein, the analysis platform may include a processing module 816, analysis module 818, and graphical user interface (GUI) module 820. Each of these modules can be an integral part of the analysis platform. Alternatively, these modules can be logically separate from the analysis platform but operate “alongside” it. Together, these modules enable the analysis platform to gain insights not only into whether the pressurizable device connected to the controller 800 is being used properly but also into the health of the human body situated on or in the two or more pressurizable devices.

The processing module 816 can process pressure data obtained by the analysis platform into a format that is suitable for the other modules. For example, in preparation for analysis by the analysis module 818, the processing module 816 may apply algorithms designed for temporal aligning, artifact removal, and the like. Accordingly, the processing module 816 may be responsible for ensuring that the pressure data is accessible to the other modules of the analysis platform. As further discussed below, the processor 802 may forward at least some of the pressure data, in either its processed or unprocessed form, to the communication module 808 for transmittal to a destination for analysis. In such a scenario, the processing module 816 may apply operations (e.g., filtering, compressing, labeling) to the pressure data before it is forwarded to the communication module 808 for transmission to the destination.

By examining the pressure data in conjunction with flow data representative of the fluid flowing into the controller 800 from the pump(s), the analysis module 818 can control how the chambers of the pressurizable devices 832, 842, 852 are inflated and/or deflated. For example, the analysis module 818 may be responsible for separately and independently controlling the set point for fluid flowing into each chamber such that the pressures of the chambers match a predetermined pattern for each pressurizable device.

By examining the pressure data, the analysis module 818 may also be able to discover, predict, or otherwise determine characteristics of the living body to which the pressurizable devices 832, 842, 852 are providing treatment. For example, the analysis module 818 may be able to sense movements of the human body under which a pressurizable device (e.g., pressure-mitigation device 100 of FIGS. 1A-B) is positioned. These movements may be caused by the user, another individual (e.g., a caregiver or an operator of the controller 800), or the underlying surface. The analysis module 818 may apply algorithms to the data representative of these movements (also referred to as “movement data” or “motion data”) to identify repetitive movements and/or random movements to better understand the health state of the user. For example, the analysis module 818 may be able to produce a coverage metric indicative of the amount of time that the human body is properly positioned on or in each pressurizable device. As further discussed below, the controller 800 (or another computing device) may be able to independently establish whether each pressurizable device has been properly deployed and/or operated based on the coverage metric. As another example, the analysis module 818 may be able to establish the respiration rate, heart rate, or another vital measurement based on the movements of the user. Generally, the movement data is derived from the pressure data. That is, the analysis module 818 may be able to infer movements of the human body by analyzing the pressure of the chambers of each of the pressurizable devices in conjunction with the rate at which fluid is being delivered to those chambers. Consequently, some embodiments of each of the pressurizable devices may not actually include any sensors for measuring movement, such as accelerometers, tilt sensors, or gyroscopes.

The analysis module 818 may respond in several ways after examining the pressure data. For example, the analysis module 818 may generate a notification (e.g., an alert) to be transmitted to another computing device by the communication module 808. The other computing device may be associated with a medical professional (e.g., a physician or a nurse), a caregiver (e.g., a family member or friend of the user), or some other entity (e.g., a researcher or an insurer). As another example, the analysis module 818 may cause the pressure data (or analyses of such data) to be integrated with the electronic health record of the user. Generally, the electronic health record is maintained in a storage medium that is accessible to the communication module 808 across a network.

Note that, in some embodiments, the analysis module 818 is also responsible for ensuring that the pressurizable devices 832, 842, 852 are either sequentially or simultaneously controlled in a logical manner. For example, assume that a living body is receiving treatment from a pressure-mitigation device, as shown in FIGS. 1A-B, and an IPC device, as shown in FIG. 2. The pressure-mitigation device and IPC device can be inflated in accordance with different patterns. However, there may be scenarios where it is important that these patterns be synchronized in some manner. For instance, it may be desirable to inflate the IPC device either synchronously or asynchronously with the pressure-mitigation device in an effort to induce or promote blood flow from the lumbar region into the femoral and calf regions. As another example, if the controller is responsible for managing fluid flow into a vital signs monitoring device 400, it may be desirable for the analysis module 818 to coordinate that fluid flow with fluid flow into a pressure-mitigation device to reduce the likelihood of improper measurements. As a specific example, the analysis module 818 may indicate—to the processor 802—that fluid flow into the pressure-mitigation device should stop entirely while the vital signs monitoring device 400 is generating one or more measurements. Accordingly, the analysis module 818 may manipulate a programmed pattern indicating how fluid should flow into one pressure-mitigation device based on an analysis of another programmed pattern indicating how fluid should flow into another pressure-mitigation device.

The GUI module 820 may be responsible for generating interfaces that can be presented on the display 806. Various types of information can be presented on these interfaces. For example, information that is calculated, derived, or otherwise obtained by the analysis module 818 may be presented on an interface for display to the user or operator. As another example, visual feedback may be presented on an interface so as to indicate whether the user is properly situated on or in each pressurizable device.

The controller 800 may include a power component 812 that is able to provide to the other components residing within the housing, as necessary. Examples of power components include rechargeable lithium-ion (Li-ion) batteries, rechargeable nickel-metal hydride (NiMH) batteries, rechargeable nickel-cadmium (NiCad) batteries, etc. In some embodiments, the controller 800 does not include a power component and, thus, must receive power from an external source. In such embodiments, a cable designed to facilitate the transmission of power (e.g., via a physical connection of electrical contacts) may be connected between the power interface 814 of the controller 800 and the external source. The external source may be, for example, an alternating current (AC) power socket or another computing device. The cable connected to the power interface 814 of the controller 800 may also be able to convey power so as to recharge the power component 812.

Embodiments of the controller 800 can include any subset of the components shown in FIG. 8, as well as additional components not illustrated here.

For example, while the controller 800 is able to receive and transmit data wirelessly via the communication module 808, other embodiments of the controller 800 may include a physical data interface through which data can be transmitted to another computing device. Examples of physical data interfaces include Ethernet ports, Universal Serial Bus (USB) ports, and proprietary ports.

As another example, some embodiments of the controller 800 include an audio output mechanism 822 and/or an audio input mechanism 824. The audio output mechanism 822 may be any apparatus that is able to convert electrical impulses into sound. One example of an audio output mechanism is a loudspeaker (or simply “speaker”). Meanwhile, the audio input mechanism 824 may be any apparatus that is able to convert sound into electrical impulses. One example of an audio input mechanism is a microphone. Together, the audio output and input mechanisms 822, 824 may enable the user or operator to engage in an audible exchange with a person who is not located proximate to the controller 800. Assume, for example, that the user is being treated with two or more pressurizable devices, and one of the pressurizable devices is a pressure-mitigation device upon which she is misaligned. In such a scenario, the user may utilize the audio input mechanism 824 to verbally ask for assistance, for example, from another person who is able to verbally confirm that assistance is forthcoming using the audio output mechanism 822. The other person could be a medical professional or caretaker of the user. This may be useful in situations where the user is unable to reposition herself on or in one of the pressure-mitigation devices due to an underlying condition that inhibits or prevents movement.

The audio input mechanism 824 may also be able to generate a signal that is indicative of more nuanced sounds. For example, the audio input mechanism 824 may generate data that is representative of sounds originating from within the human body situated on or in one or more of the two or more pressurizable devices. These sounds may be representative of auscultation sounds generated by the circulatory, respiratory, and gastrointestinal systems. This data could be transmitted (e.g., by the communication module 808) to a destination for analysis.

Other sensors may also be implemented in, or accessible to, the controller 800. For example, sensors may be contained in the housing of the controller 800 and/or embedded within each pressurizable device that is connected to the controller 800. Collectively, these sensors may be referred to as the “sensor suite” 826. For example, the sensor suite 826 may include a motion sensor whose output is indicative of the motion of the controller 800 or each pressurizable device, such as Device A 832, Device B 842, and/or Device C 852. Examples of motion sensors include multi-axis accelerometers and gyroscopes. As another example, the sensor suite 826 may include a proximity sensor whose output is indicative of proximity to the controller 800 or pressurizable device. A proximity sensor may include, for example, an emitter that is able to emit infrared (IR) light and a detector that is able to detect reflected IR light that is returned toward the proximity sensor. These types of proximity sensors are sometimes called laser imaging, detection, and ranging (LiDAR) scanners. Other examples of sensors include an ambient light sensor whose output is indicative of the amount of light in the ambient environment, a temperature sensor whose output is indicative of the temperature of the ambient environment, and a humidity sensor whose output is indicative of the humidity of the ambient environment. The output(s) produced by the sensor suite 826 may provide greater insight into the environment in which the controller 800 is deployed (and thus the environment in which the human body situated on or in each of the two or more pressurizable devices is to be treated).

In some embodiments, the sensor suite 826 includes one or more specialty sensors that are designed to generate, obtain, or otherwise produce information related to the health of the human body. For example, the sensor suite 826 may include a vascular scanner. The term “vascular scanner” may be used to refer to an imaging instrument that includes (i) an emitter operable to emit electromagnetic radiation (e.g., in the near infrared range) into the body and (ii) a sensor operable to sense electromagnetic radiation reflected by physiological structures inside the human body. Normally, an image is created based on the reflected electromagnetic radiation that serves as a reference template for the vasculature of an anatomical region. Thus, the vasculature in an anatomical region could be periodically or continually monitored based on outputs produced by a vascular scanner included in the sensor suite 826. Additionally or alternatively, the sensor suite 826 may include sensors that are designed to perform pulse oximetry by determining oxygen level of the blood, measure blood pressure, compute heart rate, etc.

Based on the output(s) produced by the sensor suite 826, the controller 800 (or some other computing device) may be able to compute some or all of the main vital signs, namely, body temperature, blood pressure, pulse rate, and breathing rate (also referred to as “respiratory rate”). Moreover, the controller 800 (or some other computing device) may be able to compute metrics that are indicative of the health of the human body despite not being one of the main vital signs. For example, output(s) generated by the sensor suite 826 could be used to establish whether the human body is performing a given activity (e.g., sleeping or eating). The output(s) could be used to ascertain not only the sleep pattern of the human body but also whether changes in the sleep pattern indicate whether the health state of the human body has improved (e.g., sleep more consistent with longer duration following deployment of a pressure-mitigation device).

Note that the sensors included in the sensor suite 826 need not necessarily be included in the controller 800. For example, the controller 800 may be communicatively connected to ancillary sensors that are included in various items (e.g., blankets and clothing), attached to the human body, etc.

These various components may allow the controller 800 to be readily integrated into a network-connected environment, such as a home or hospital. Thus, the controller 800 may be communicatively coupled to mobile phones, tablet computers, wearable electronic devices (e.g., fitness trackers and watches), or network-connected devices (also referred to as “smart devices”), such as televisions and home assistant devices. Similarly, the controller 800 may be communicatively coupled to medical devices, such as cardiac pacemakers, insulin pumps, glucose monitoring devices, and the like. This level of integration can provide several notable benefits over conventional technologies for mitigating pressure.

As an example, the pressure-mitigation system of which the controller 800 is a part may be used to monitor health of a human body in a more holistic sense. As mentioned above, insights into movements of the human body can be surfaced through analysis of pressure data generated by the controller 800 or pressurizable devices. Analysis of these movements over an extended period of time (e.g., days, weeks, or months) may lead to the discovery of abnormalities that might otherwise go unnoticed. For example, the controller 800 (or some other computing device) may infer that the human body is suffering from an ailment in response to a determination that its movements over a recent interval of time differ from those that would be expected based on past intervals of time. At a high level, insights gained through analysis of the pressure data can be used not only to define a “health baseline” for the human body but also to discover when deviations from the health baseline occur.

As another example, the controller 800 may be responsible for providing or supplementing prompts to administer medication in accordance with a regimen. Assume, for example, that a user positioned on or in one or more of the two or more pressurizable devices is associated with a regimen that requires a medication to be administered regularly. The controller 800 may promote adherence to the regimen by prompting the user or another person (e.g., an operator of the controller 800) to administer the medication. Visual notifications could be presented by the display 806, or audible notifications could be presented by the audio output mechanism 822. Additionally or alternatively, the controller 800 could cause digital notifications (also referred to as “electronic notifications”) to be presented by a computing device that is communicatively coupled to the controller 800. In some embodiments, the regimen is stored in the memory 804 of the controller 800. In other embodiments, the regimen is stored in the memory of a computing device that is communicatively coupled to the controller 800. For example, the regimen may be implemented by a computer program that is executing on a mobile device associated with the user, and when the computer program determines that a dose of the medication is due to be administered, the computer program may transmit an instruction to the controller 800 to generate a notification.

As another example, the controller 800 may be able to facilitate communication with medical professionals. Assume, for example, that the controller 800 is deployed in a home environment that medical professionals visit infrequently or not at all. In such a scenario, the controller 800 may allow the user to communicate with medical professionals who are located outside of the home environment. Thus, the user may be able to communicate, via the audio output and input mechanisms 822, 824, with medical professionals who are located in a hospital environment (e.g., at which the user received treatment) or their own home environments.

As another example, the controller 800 may be able to facilitate communication with emergency services. For instance, if the controller 800 determines (e.g., through analysis of pressure data) that no movement has occurred for a predetermined amount of time, the controller 800 may prompt the user to respond. Similarly, if the controller 800 receives input from the user indicative of a request for assistance, the controller 800 may initiate communication with emergency services. Thus, the controller 800 may be programmed to perform some action if, for example, it determines (e.g., through analysis of the signal generated by the audio input mechanism 824) that the user has indicated she has fallen or has experienced a medical event (e.g., shortness of breath, heart palpitations, excessive sweating).

These benefits allow pressure-mitigation systems to be deployed in situations where frequent visits by medical professionals may not be practical or possible. For example, when deployed in a hospital environment, a pressure-mitigation system may allow medical professionals to visit patients less frequently. Patients situated on or in two or more pressurizable devices may not need to be turned to alleviate pressure as often, and medical professionals may not need to continually check on patients if pressure-mitigation systems are able to autonomously discover changes in health. As another example, when deployed in a home environment, a pressure-mitigation system may be able to counter a lack of visits from medical professionals. If a patient is instructed to situate herself on or in one or more of two or more pressure-mitigation devices while at home, the patient may only need to be visited every few (e.g., three, five, or seven) days rather than once per day or multiple times per day. Overall, implementing pressure-mitigation systems can lead to significant cost savings because medical professionals are required to make less frequent visits and perform fewer medical procedures and because patients can be discharged more quickly.

The controller 800 may also be designed to focus on wellness in addition to, or instead of, treatment for (and prevention of) pressure-induced injuries. As an example, embodiments of the controller 800 may be designed to aid in sleep management for healthy individuals and/or unhealthy individuals. Using the audio output mechanism 822 in combination with the manifold 810, the controller 800 may be able to accomplish tasks such as simulating the presence of another person, for example, by producing vocal sounds, breathing sounds, applying pressure, and the like.

FIG. 9 is an isometric view of a manifold 900 for independently controlling the flow of fluid (e.g., air) to the chambers of two or more pressurizable devices in accordance with embodiments of the present technology. As discussed above, a controller can be configured to independently inflate and/or deflate each chamber of two or more pressurizable devices to create pressure gradients that move the main points of pressure applied by objects across surfaces of a human body situated on or in the two or more pressurizable devices. To accomplish this, the manifold 900 can guide fluid to the chambers through a series of valves 902. In some embodiments, each valve 902 corresponds to a separate chamber of each of the pressurizable devices. In some embodiments, at least one valve 902 corresponds to multiple chambers of each of the pressurizable devices. In some embodiments, at least one valve 902 is not used during operation. For example, if one of the pressurizable devices is a pressure-mitigation device that includes four chambers, multi-channel tubing may be connected between that pressure-mitigation device and four valves 902 of the manifold 900. In such embodiments, the other valves may remain sealed during operation. Each fluid interface of the controller can be associated with its own manifold, wherein each fluid interface can be linked to its own pressurizable device. Thus, the manifold can be “scaled up” depending on the number of pressurizable devices to be connected to the controller, in which case each fluid interface (and, therefore, each pressurizable device) can be associated with a subset of the valves 902.

Generally, the valves 902 are piezoelectric valves designed to switch from one state (e.g., an open state) to another state (e.g., a closed state) in response to an application of voltage. Each piezoelectric valve includes at least one piezoelectric element that acts as an electromechanical transducer. When a voltage is applied to the piezoelectric element, the piezoelectric element is deformed, thereby resulting in mechanical motion (e.g., the opening or closing of a valve). Examples of piezoelectric elements include disc transducers, bender actuators, and piezoelectric stacks.

Piezoelectric valves provide several benefits over other valves, such as linear valves and solenoid-based valves. First, piezoelectric valves do not require holding current to maintain a state. As such, piezoelectric valves generate almost no heat. Second, piezoelectric valves create almost no noise when switching between states, which can be particularly useful in medical settings. Third, piezoelectric valves can be opened and closed in a controlled manner that allows the manifold 900 to precisely approach a desired flow rate without overshooting or undershooting. In contrast, the other valves described above must be in either an open state, in which the valve is completely open, or a closed state, in which the valve is completely closed. Fourth, piezoelectric valves require very little power to operate, so a power component (e.g., the power component 812 of FIG. 8) may need to provide only 3-6 watts to the manifold 900 at any given time. While embodiments of the manifold 900 may be described in the context of piezoelectric valves, other types of valves, such as linear valves or solenoid-based valves, could be used instead of, or in addition to, piezoelectric valves.

In some embodiments, the manifold 900 includes one or more transducers 906 and a circuit board 904 that includes one or more integrated circuits (also referred to as “chips”) for managing communication with the valves 902 and the transducer(s) 906. Because these local chip(s) reside within the manifold 900 itself, the valves 902 can be digitally controlled in a precise manner. The local chip(s) may be connected to other components of the controller. For example, the local chip(s) may be connected to other components housed within the controller, such as processors (e.g., processor 802 of FIG. 8) and clock modules. The transducer(s) 906, meanwhile, can generate an electrical signal based on the pressure of each chamber of each pressurizable device. Generally, each chamber is associated with a different valve 902 and a different transducer 906. Here, for example, the manifold includes six valves 902 capable of interfacing with a pressurizable device, and each of these valves may be associated with a corresponding transducer 906. Pressure data representative of the values of the electrical signals generated by the transducer(s) 906 can be provided to other components of the controller for further analysis.

The manifold 900 may also include one or more compressors. In some embodiments, each valve 902 of the manifold 900 is fluidically coupled to the same compressor, while in other embodiments, each valve 902 of the manifold 900 is fluidically coupled to a different compressor. Each compressor can increase the pressure of fluid by reducing its volume before guiding the fluid to a specific pressurizable device.

Fluid produced by a pump may initially be received by the manifold 900 through one or more ingress fluid interfaces 908 (or simply “ingress interfaces”). As noted above, in some embodiments, a compressor may then increase pressure of the fluid by reducing its volume. Thereafter, the manifold 900 can controllably and independently guide the fluid into one or more chambers of two or more pressurizable devices through the valves 902. The flow of fluid into each chamber can be controlled by local chip(s) disposed on the circuit board 904. For example, the local chip(s) can dynamically vary the flow of fluid into each chamber in real time by controllably applying voltages to open/close the valves 902.

In some embodiments, the manifold includes one or more egress fluid interfaces 910 (or simply “egress interfaces”). The egress fluid interface(s) 910 may be designed for high pressure and high flow to permit rapid deflation of the pressurizable device. For example, upon determining that an operator has provided input indicative of a request to deflate the pressurizable device (or a portion thereof), the manifold 900 may allow fluid to travel back through the valve(s) 902 from the pressurizable device and then out through the egress fluid interface(s) 910. Thus, the egress fluid interface(s) 910 may also be referred to as “exhausts” or “outlets.” To provide the input, the operator may interact with a mechanical input component (e.g., mechanical input component 706 of FIG. 7A) or a digital input component (e.g., visible on display 710 of FIG. 7A).

FIG. 10 is a generalized electrical diagram illustrating how the piezoelectric valves 1002 of a manifold can separately control the flow of fluid along multiple channels in accordance with embodiments of the present technology. In FIG. 10, the manifold includes seven piezoelectric valves 1002. Other embodiments of the manifold may include fewer than seven valves or more than seven valves. Fluid, such as air, can be guided by the manifold through the piezoelectric valves 1002 to the chambers of each of two or more pressurizable devices. In FIG. 10, the manifold is fluidically connected to a pressurizable device that has five chambers. However, in other embodiments, the manifold may be fluidically connected to a pressurizable device that has fewer than five chambers or more than five chambers. In some embodiments, the manifold may be fluidically connected to two or more pressurizable devices that, in sum, have fewer than five chambers or more than five chambers. In yet other embodiments, each fluid interface of the controller can be associated with its own manifold, wherein each fluid interface can be linked to its own pressurizable device. Thus, the manifold can be “scaled up” or modified depending on the number of pressurizable devices to be connected to the controller, in which case each fluid interface (and, therefore, each pressurizable device) can be associated with a subset of the valves. In some embodiments, different fluid interfaces (and, therefore, different pressurizable devices) have different numbers of chambers. Thus, while FIG. 10 provides an example of how the manifold could control five chambers with seven valves, embodiments could include different numbers of values. Each pressurizable device could be driven in accordance with a diagram like the one shown in FIG. 10. Therefore, there could exist multiple “fluid flow diagrams” that are implemented by the controller to simultaneously accommodate multiple pressurizable apparatuses.

All of the piezoelectric valves 1002 included in the manifold need not necessarily be identical to one another. Piezoelectric valves may be designed for high pressure and low flow, high pressure and high flow, low pressure and low flow, or low pressure and high flow. In some embodiments, all of the piezoelectric valves included in the manifold are the same type, while in other embodiments, the manifold includes multiple types of piezoelectric valves. For example, piezoelectric valves corresponding to side supports of a pressure-mitigation device may be designed for high pressure and high flow (e.g., to allow for a quick discharge of fluid stored therein), while piezoelectric valves corresponding to chambers of a pressure-mitigation device may be designed for high pressure and low flow. Moreover, some piezoelectric valves may support bidirectional fluid flow, while other piezoelectric valves may support unidirectional fluid flow. Generally, if the manifold includes unidirectional piezoelectric valves, each chamber in each pressurizable device is associated with a pair of unidirectional piezoelectric valves to allow fluid flow in either direction. Here, for example, Chambers 1-3 are associated with a single bidirectional piezoelectric valve, Chamber 4 is associated with two bidirectional piezoelectric valves, and Chamber 5 is associated with two unidirectional piezoelectric valves.

The chambers of a pressurizable device may be independently inflated/deflated for a predetermined duration of 15-180 seconds (e.g., 30 seconds, 60 seconds, 90 seconds, 120 seconds, 150 seconds, or any duration therebetween) in accordance with a predetermined pattern. Thus, the status of each chamber may be varied at least every 60 seconds, 90 seconds, 120 seconds, 240 seconds, etc. Generally, the predetermined pattern causes the chambers to be inflated/deflated in a nonidentical manner. For example, if a pressurizable device is a pressure-mitigation device that includes four chambers, the first and second chambers may be inflated for 30 seconds, the second and third chambers may be inflated for 45 seconds, the third and fourth chambers may be inflated for 30 seconds, and then the first and fourth chambers may be inflated for 45 seconds. These chambers may be inflated/deflated to a predetermined pressure level from 0 -100 millimeters of mercury (mmHg) (e.g., 15 mmHg, 20 mmHg, 30 mmHg, 45 mmHg, 50 mmHg, or any pressure level therebetween). In some embodiments, the inflation pattern administered by the controller inflates/deflates two or more chambers at one time. In these embodiments, the chambers can be inflated/deflated to the same or different pressure levels, and the duration that the chambers are maintained at the pressure levels may be the same or different. For example, in the scenario above where the first and second chambers are inflated, the first chamber may be inflated to a pressure of 15 mmHg, while the second chamber may be inflated to a pressure of 30 mmHg. In other embodiments, the controller can apply different inflation/deflation patterns to the individual chambers.

In some embodiments, the number of modular assemblies needed to controllably inflate a given pressurizable device is based on the number of channels into which fluid can flow. In FIG. 1A, for example, the pressure-mitigation device 100 includes four channels, namely, three channels for the three chambers and one channel shared between the side supports. Each modular assembly can be designed to support a predetermined number of channels. For example, modular assemblies may be designed to support a single channel, or modular assemblies may be designed to support more than one channel (e.g., two or three channels).

In other embodiments, the number of modular assemblies needed to controllably inflate a given pressurizable device is based on a characteristic of a human body to be situated thereon, a characteristic of the surface on which the given pressurizable device is to be deployed, or a purpose of the given pressurizable device. For example, each modular assembly may be “weight rated” for a certain number of pounds, and the number of modular assemblies that are needed may depend on the weight of the human body to be supported by a pressure-mitigation device.

### Methodologies for Relieving Pressure on a Human Body

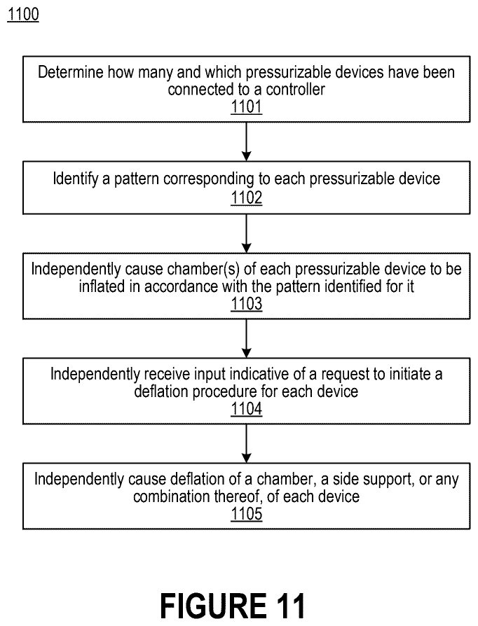

FIG. 11 is a flow diagram of a process 1100 for varying the pressure in the chambers of two or more pressurizable devices that are positioned between a human body and two or more surfaces in accordance with embodiments of the present technology. By independently varying the pressure in the chambers, a controller can move the main points of pressure applied by each surface across the human body. For example, the main point of pressure applied by each support surface to the human body may be moved among multiple predetermined locations by sequentially varying the pressure in different predetermined subsets of chambers. Note that the human body could be in nearly any position, with minimal changes to the process 1100. Thus, the two or more pressurizable devices may be arranged so that pressure is applied to or mitigated in at least one anatomical region located at one or more specific points along the human body. The same controller can independently control or direct the two or more pressurizable devices. In some embodiments, the controller independently directs fluid flow or airflow into the two or more pressurizable devices.

Initially, a controller can determine how many and which pressurizable devices have been connected to the controller (step 1101). The controller may detect which type of pressurizable device has been connected by monitoring the connection between a fluid interface (e.g., the fluid interface 708 of FIG. 7B) and the pressurizable device. Each type of pressurizable device may include a different type of connector. For example, a pressure-mitigation device designed for deployment on elongated objects (e.g., pressure-mitigation device 100 of FIGS. 1A-B) may include a first arrangement of magnets in its connector, and a pressure-mitigation apparatus designed for deployment on non-elongated objects may include a second arrangement of magnets in its connector. The controller may determine which type of pressurizable device (and, more specifically, which type of pressure-mitigation apparatus) has been connected based on which magnets have been detected within a specified proximity. As another example, the pressure-mitigation device designed for deployment on elongated objects may include a beacon capable of emitting a first electronic signature, while the pressure-mitigation device designed for deployment on non-elongated objects may include a beacon capable of emitting a second electronic signature. Examples of beacons include Bluetooth beacons, USB beacons, and infrared beacons. A beacon may be configured to communicate with the controller via a wired communication channel or a wireless communication channel.

The controller can then identify a pattern that is associated with each pressurizable device (step 1102). For example, the controller may examine a library of patterns corresponding to different pressurizable devices to identify the appropriate pattern. The library of patterns may be stored in a local memory (e.g., the memory 804 of FIG. 8) or a remote memory that is accessible to the controller across a network. The controller may modify an existing pattern based on the given pressurizable device, the user, the ailment affecting the user, etc. For example, the controller may alter an existing pattern responsive to determining that the pattern includes instructions for more chambers than the pressurizable device includes. As another example, the controller may alter an existing pattern responsive to determining that the weight of the user exceeds a predetermined threshold.

In some embodiments, the pattern is associated with a characteristic of the user in addition to, or instead of, a given pressurizable device. For example, the controller may examine a library of patterns corresponding to different ailments or different anatomical regions to identify the appropriate pattern. Thus, the library may include patterns associated with anatomical regions along the anterior side of the human body, patterns associated with anatomical regions along the posterior side of the human body, or patterns associated with different ailments (e.g., ulcers, strokes, etc.).

The controller can then independently cause the chambers of each pressurizable apparatus to be inflated in accordance with the pattern specific for each pressurizable apparatus (step 1103). As discussed above, the controller can cause the pressure on one or more anatomical regions of the human body to be varied by controllably inflating one or more chambers, deflating one or more chambers, or any combination thereof. For example, upon receiving input that is indicative of a request to initiate a deflation procedure for a given pressurizable apparatus (step 1104), the controller can cause deflation of one or more chambers of the given pressurizable apparatus (step 1105). Generally, all chambers of the given pressurizable apparatus are deflated as part of the deflation procedure. If, for example, the pressurizable apparatus is a pressure-mitigation device, the controller can cause deflation of its chambers and/or side supports. Steps 1104-1105 can be independently performed for each pressurizable device that is fluidically coupled to the controller.

Other steps may be performed in some embodiments. As an example, the controller may be configured to independently regulate inflation of the chambers based on a total duration of use of each pressurizable device. For instance, the controller may increase or decrease the flow of air into the chambers (and thus the pressure of those chambers) in a continual, periodic, or ad hoc manner to account for extended applications of pressure on the human body. In some embodiments, the controller determines the total duration of use based on a clock signal generated by a clock module housed in the controller. In other embodiments, the controller determines the total duration of use based on signal(s) generated by some other computing device. For instance, the controller may be able to infer how long each pressurizable device has been used based on the presence of a signal generated by a computing device associated with the patient, such as a mobile phone or wearable electronic device. Said another way, the controller may infer the presence of the patient based on whether her computing device is located within a given proximity. For example, the controller may infer that a given pressurizable device has been in use so long as the computing device is (1) presently detectable (e.g., via a point-to-point wireless channel, such as Bluetooth or Wi-Fi P2P) and (2) has been detectable for at least a certain amount of time (e.g., more than three minutes, five minutes, etc.).

Those skilled in the art will recognize that the approaches to mitigating or applying the pressure described herein may be useful in various contexts. Several examples are provided below; however, these examples should not be construed as limiting in any sense. Instead, these examples are provided to illustrate the usefulness of mitigating pressure in a few different scenarios.

### Overview of Pressure-Mitigation Systems

FIG. 12 is a partially schematic side view of a pressure-mitigation system 1200 (or simply “system”) for orienting a patient 1202 (also referred to as a “user”) over an alignment-facilitating device 1206 and in other pressure-mitigation devices, such as a deep vein thrombosis (DVT) compressor 200, an intermittent pneumatic compression (IPC) device 300, and a vital signs monitoring device 400, in accordance with embodiments of the present technology. Here, the system 1200 includes an alignment-facilitating device 1206 that includes side supports 1208, an attachment device 1204, a pressure device 1214, and a controller 1212. Other embodiments of the system 1200 may include a subset of these components. For example, the system 1200 may include an alignment-facilitating device 1206, a pressure device 1214, and a controller 1212. The alignment-facilitating device 1206 is discussed in further detail with respect to FIGS. 1A-4, the DVT compressor 200 is discussed in further detail with respect to FIG. 2, the IPC device 300 is discussed in further detail with respect to FIG. 3, the vital signs monitoring device 400 is discussed in further detail with respect to FIG. 4, and the controller 1212 is discussed in further detail with respect to FIGS. 7A-10.

In this embodiment, the alignment-facilitating device 1206 includes a pair of elevated side supports 1208 that extend longitudinally along opposing sides of the alignment-facilitating device 1206. Some embodiments of the alignment-facilitating device 1206 do not include any elevated side supports. For example, side supports may not be necessary if the object on which the user 1202 is positioned includes lateral structures that prevent or inhibit horizontal movement or if the user 1202 will be completely immobilized (e.g., using anesthesia). The alignment-facilitating device 1206 includes a series of chambers interconnected on a base material that may be arranged in a geometric pattern designed to mitigate the pressure applied to an anatomical region by the surface of the object 1218.

The elevated side supports 1208 can be configured to actively orient an anatomical region of the user 1202 over a series of chambers. For example, the elevated side supports 1208 may be responsible for actively orienting an anatomical region widthwise over the epicenter of the geometric pattern. As shown in FIG. 12, an anatomical region may be the sacral region. However, the anatomical region could be any region of the human body that is susceptible to pressure. The elevated side supports 1208 may be configured to be ergonomically comfortable. For example, the elevated side supports 1208 may include a recess designed to accommodate the forearm that permits pressure to be offloaded from the elbow. The elevated side supports 1208 may be significantly larger in size than the chambers of the alignment-facilitating device 1206. Accordingly, the elevated side supports 1208 may create a barrier that restricts lateral movement of the user 1202. In some embodiments, the elevated side supports are approximately 2-3 inches taller in height as compared to the average height of an inflated chamber. Because the elevated side supports 1208 straddle the user 1202, the elevated side supports 1208 can act as barriers for maintaining the position of the user 1202 on top of the alignment-facilitating device 1206. As discussed above, the elevated side supports 1208 may be omitted in some embodiments. For example, the elevated side supports 1208 may be omitted if the user 1202 suffers from impaired mobility due to physical injury, structural components that limit movement, anesthesia, or some other condition that limits natural movement.

In some embodiments, the inner sidewalls of the elevated side supports 1208 form, following inflation, a firm surface at a steep angle of orientation with respect to the alignment-facilitating device 1206. For example, the inner sidewalls may be on a plane of approximately 115 degrees, plus or minus 24 degrees, from the plane of the alignment-facilitating device 1206. These steep inner sidewalls can form a channel that naturally positions the user 1202 over the chambers of the alignment-facilitating device 1206. Thus, inflation of the elevated side supports 1208 may actively force the user 1202 into the appropriate position for mitigating pressure by orienting the body in the correct location with respect to the chambers of the alignment-facilitating device 1206.

After the initial inflation cycle has been completed, the pressure of each elevated side support 1208 may be lessened to increase comfort and prevent excessive force against the lateral sides of the user 1202. Oftentimes, a medical professional will be present during the initial inflation cycle to ensure that the elevated side supports 1208 properly position the user 1202 over the alignment-facilitating device 1206, though that need not necessarily be the case (e.g., if the alignment-facilitating device 1206 is deployed in a home environment). In the exemplary system 1200 illustrated, the controller 1212 can independently control fluid flow through conduits or tubing 1210 to one or more chambers of the alignment-facilitating device 1206, the DVT compressor 200, the IPC device 300, and the vital signs monitoring device 400.

The controller 1212 can be configured to regulate the pressure of each chamber in the alignment-facilitating device 1206 (and the elevated side supports 1208 if included) via one or more flows of air generated by a pressure device 1214. One example of a pressure device is an air pump. These flow(s) of air can be guided from the controller 1212 to one of the two or more pressurizable devices, such as the alignment-facilitating device 1206 via tubing 1210. For example, the chambers may be controlled in a specific pattern to preserve blood flow and reduce pressure applied to the user 1202 when inflated (i.e., pressurized) and deflated (i.e., depressurized) in a coordinated fashion by the controller 1212. As shown in FIG. 12, tubing 1210 may be connected between each pressure-mitigation device and the controller 1212. Accordingly, for example, the alignment-facilitating device 1206 may be fluidically coupled to a first end of tubing (e.g., single-channel tubing or multi-channel tubing), while the controller 1212 may be fluidically coupled to a second end of the tubing. While the pressure device 1214 is normally housed within the controller 1212, these components could be connected via tubing. Thus, the pressure device 1214 could be fluidically coupled to a first end of tubing (e.g., single-channel tubing or multi-channel tubing), while the controller 1212 may be fluidically coupled to a second end of the tubing. As mentioned above, the multi-channel tubing 1210 may not be needed in some embodiments. For example, the controller 1212 could be directly attached to the alignment-facilitating device 1206, thereby eliminating the need for tubing between the controller 1212 and alignment-facilitating device 1206.

As discussed above, some embodiments of the system 1200 include a communication module configured to facilitate wireless communication with nearby computing devices. For example, the controller 1212 may include a communication module able to wirelessly communicate with hospital equipment 1216 involved in treatment of the user 1202. Examples of hospital equipment include medical devices, such as extracorporeal membrane oxygenation (ECMO) machines, mechanical ventilators, blood pressure monitors, stethoscopes, blood glucose sensors, heart rate sensors, pulse oximeters, and the like, and other computing devices, such as mobile workstations, monitors, storage mediums, and the like. The controller 1212 may be able to independently pressurize each inflatable chamber of each pressurizable device based on information obtained from the hospital equipment. For instance, the controller 1212 may alter programmed patterns for pressurizing the inflatable chambers of each pressure-mitigation device based on the current status of the hospital equipment 1216, whether the hospital equipment 1216 indicates that there is a problem, etc. As an example, the controller 1212 may receive, via the communication module, input from a mechanical ventilator that a procedure (e.g., suctioning, spraying of medication, bronchoscopy) will be performed. In such a scenario, the controller 1212 may cause all inflatable chambers of the alignment-facilitating device 1206 to be pressurized (i.e., inflated) or depressurized (i.e., deflated) so that the procedure is easier to perform. Thus, the controller 1212 may discontinue treatment in accordance with the programmed pattern responsive to determining that it is not safe, appropriate, or desirable to continue treatment.

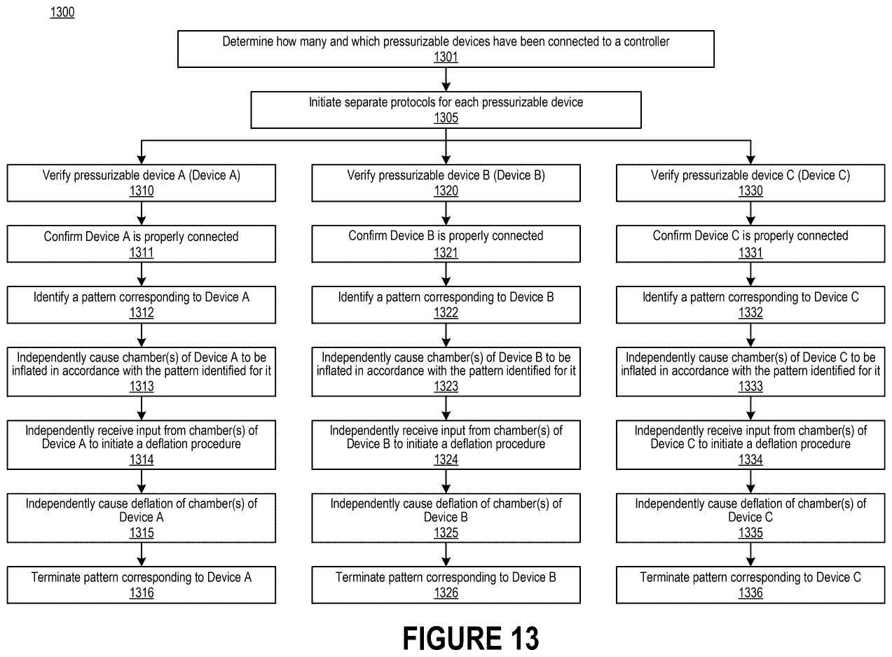

FIG. 13 is an example of a flow diagram of a process 1300 for independently directing fluid flow into each chamber of two or more pressurizable devices that are attached to or juxtaposed to a human body in accordance with embodiments of the present technology. In the first step 1301 of this process, the controller determines how many and which pressurizable devices have been connected to the controller. In the second step 1305 of this process, the controller initiates separate protocols for each pressurizable device identified. Thereafter, for each pressurizable device, the controller independently proceeds through multiple steps. In the system illustrated in FIG. 13, the controller is attached to three pressurizable devices, Device A, Device B, and Device C. For each device, the controller independently proceeds through at least the following steps. First, for Device A 1310 (or Device B 1320 or Device C 1330), the controller verifies the pressurizable device. For example, for each pressurizable device, the controller may confirm that an appropriate programmed pattern is available. Second, the controller confirms that Device A 1311 (or Device B 1321 or Device C 1331) is properly connected. For example, for each pressurizable device, the controller may establish that a cable has been properly secured to a corresponding egress interface through which fluid is guided to that pressurizable device so as to ensure that fluid is not inadvertently discharged into the ambient environment. The controller may be able to determine whether a cable has been properly secured to a given egress interface by examining the rate at which fluid is flowing therethrough and comparing the rate to the programmed pattern. Third, the controller identifies a pattern corresponding to Device A 1312 (or Device B 1322 or Device C 1332). Fourth, the controller independently causes chamber(s) of Device A 1313 (or Device B 1323 or Device C 1333) to be inflated in accordance with the pattern identified for it. Fifth, the controller independently receives input from chamber(s) of Device A 1314 (or Device B 1324 or Device C 1334) to initiate a deflation procedure. Sixth, the controller independently causes deflation of chamber(s) of Device A 1315 (or Device B 1325 or Device C 1335). And seventh, the controller terminates the pattern corresponding to Device A 1316 (or Device B 1326 or Device C 1336).

### Processing System

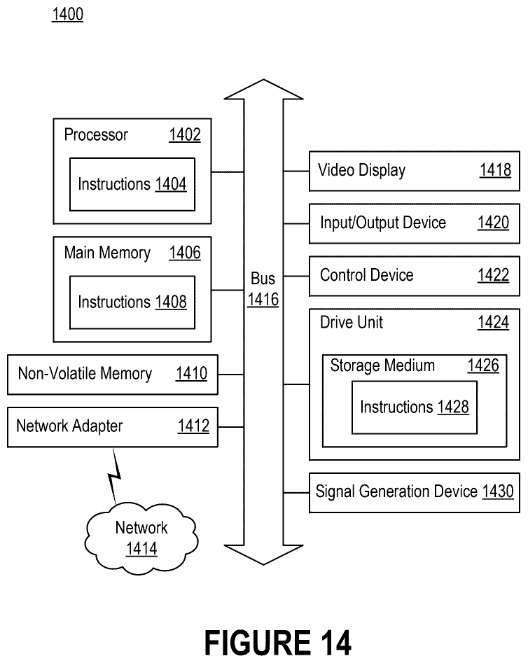

FIG. 14 is a block diagram illustrating an example of a processing system 1400 in which at least some operations described herein can be implemented. For example, components of the processing system 1400 may be hosted on a controller (e.g., controller 1212 of FIG. 12) responsible for controlling the flow of fluid to each pressurizable device (e.g., alignment-facilitating device 1206 of FIG. 12). As another example, components of the processing system 1400 may be hosted on a computing device that is communicatively coupled to the controller.

The processing system 1400 may include a processor 1402, main memory 1406, non-volatile memory 1410, network adapter 1412 (e.g., a network interface), video display 1418, input/output device 1420, control device 1422 (e.g., a keyboard, pointing device, or mechanical input such as a button), drive unit 1424 that includes a storage medium 1426, or signal generation device 1430 that are communicatively connected to a bus 1416. The bus 1416 is illustrated as an abstraction that represents one or more physical buses and/or point-to-point connections that are connected by appropriate bridges, adapters, or controllers. The bus 1416, therefore, can include a system bus, Peripheral Component Interconnect (PCI) bus, PCI-Express bus, HyperTransport bus, Industry Standard Architecture (ISA) bus, Small Computer System Interface (SCSI) bus, Universal Serial Bus (USB), Inter-Integrated Circuit (I²C) bus, or bus compliant with Institute of Electrical and Electronics Engineers (IEEE) Standard 1394.

The processing system 1400 may share a similar computer processor architecture as that of a computer server, router, desktop computer, tablet computer, mobile phone, video game console, wearable electronic device (e.g., a watch or fitness tracker), network-connected (“smart”) device (e.g., a television or home assistant device), an augmented or virtual reality system (e.g., a head-mounted display), or another computing device capable of executing a set of instructions (sequential or otherwise) that specify action(s) to be taken by the processing system 1400.

While the main memory 1406, non-volatile memory 1410, and storage medium 1426 are shown to be a single medium, the terms “storage medium” and “machine-readable medium” should be taken to include a single medium or multiple media that store one or more sets of instructions. The terms “storage medium” and “machine-readable medium” should also be taken to include any medium that is capable of storing, encoding, or carrying a set of instructions for execution by the processing system 1400.

In general, the routines executed to implement the embodiments of the present disclosure may be implemented as part of an operating system or a specific application, component, program, object, module, or sequence of instructions (collectively referred to as “computer programs”). The computer programs typically comprise one or more instructions (e.g., instructions 1404, 1408, 1428) set at various times in various memories and storage devices in a computing device. When read and executed by the processor 1402, the instructions cause the processing system 1400 to perform operations to execute various aspects of the present disclosure.

While embodiments have been described in the context of fully functioning computing devices, those skilled in the art will appreciate that the various embodiments are capable of being distributed as a program product in a variety of forms. The present disclosure applies regardless of the particular type of machine-or computer-readable medium used to actually cause the distribution. Further examples of machine-and computer-readable media include recordable-type media such as volatile and non-volatile memory 1410, removable disks, hard disk drives, optical disks (e.g., Compact Disc Read-Only Memory (CD-ROMS) and Digital Versatile Disks (DVDs)), cloud-based storage, and transmission-type media such as digital and analog communication links.

The network adapter 1412 enables the processing system 1400 to mediate data in a network 1414 with an entity that is external to the processing system 1400 through any communication protocol supported by the processing system 1400 and the external entity. The network adapter 1412 can include a network adapter card, a wireless network interface card, a switch, a protocol converter, a gateway, a bridge, a hub, a receiver, a repeater, or a transceiver that includes an integrated circuit (e.g., enabling communication over Bluetooth or Wi-Fi).

The techniques introduced here can be implemented using software, firmware, hardware, or a combination of such forms. For example, aspects of the present disclosure may be implemented using special-purpose hardwired (i.e., non-programmable) circuitry in the form of application-specific integrated circuits (ASICs), programmable logic devices (PLDs), field-programmable gate arrays (FPGAs), and the like.

### EXAMPLES

Several aspects of the technology described in the present disclosure are set forth in the following examples.
1. A controller comprising:
   a structural body that includes
      (i) a first egress interface that is fluidically coupled to a first pressurizable device with one or more chambers that, when inflated, cause pressure to be applied to, or relieved from, a first anatomical region of a living body, and
      (ii) a second egress interface that is fluidically coupled to a second pressurizable device with one or more chambers that, when inflated, cause pressure to be applied to, or relieved from, a second anatomical region of the living body;
   a processor; and
   a memory that includes instructions for regulating fluid flow into the first and second pressurizable devices in a controlled manner,
      wherein the instructions, when executed by the processor, cause the processor to:
         identify a first programmed pattern corresponding to the first pressurizable device,
         cause the one or more chambers of the first pressurizable device to be inflated in accordance with the first programmed pattern,
         identify a second programmed pattern corresponding to the second pressurizable device, and
         cause the one or more chambers of the second pressurizable device to be inflated in accordance with the second programmed pattern.
2. The controller of example 1, wherein the structural body further includes an ingress interface that is fluidically coupled to a pump that supplies a flow of fluid that is manipulated by the controller to inflate the first and second pressurizable devices in accordance with the first and second programmed patterns, respectively.
3. The controller of example 1,
   wherein the first pressurizable device is a pressure-mitigation apparatus that includes a geometric arrangement of multiple chambers to be situated between the living body and an underlying surface, and
   wherein the second pressurizable device is a deep vein thrombosis (DVT) compressor, an intermittent pneumatic compression (IPC) device, or a vital sign monitoring device.
4. The controller of example 1, wherein the processor is further configured to:
   modify the second programmed pattern based on an analysis of the first programmed pattern.
5. The controller of example 1,
   wherein the controller further comprises:
      a communication module configured to:
         initiate communication with a source that is external to the controller, and
         receive, from the source, data associated with the living body; and
   wherein the processor is further configured to:
      modify the first programmed pattern and/or the second programmed pattern based on an analysis of the data.
6. The controller of example 5, wherein the source is hospital equipment that generates or stores the data.
7. A method performed by a controller that is fluidically connected to multiple pressurizable devices that apply force to, or alleviate force applied to, different anatomical regions of a living body, the method comprising:
receiving input indicative of a request to treat the living body with the multiple pressurizable devices;
identifying multiple programmed patterns for the multiple pressurizable devices; and
causing each of the multiple pressurizable devices to be controllably inflated to varying degrees in accordance with a corresponding one of the multiple programmed patterns.
8. The method of example 7, wherein said receiving comprises:
   for each of the multiple pressurizable devices,
      receiving a separate input indicative of an acknowledgment that that pressurizable device is fluidically coupled to the controller.
9. The method of example 7, wherein the multiple pressurizable devices include at least two different types of pressurizable device.
10. The method of example 7, further comprising:
   establishing a type of pressurizable device for each of the multiple pressurizable devices;
   wherein the multiple programmed patterns are identified from among a plurality of programmed patterns based on the types of the multiple pressurizable devices.
11. The method of example 10, wherein for each of the multiple pressurizable devices, said establishing is based on an analysis of an output produced by a sensor located proximate to a corresponding one of multiple egress interfaces to which the multiple pressurizable devices are fluidically coupled.
12. The method of example 10, wherein for each of the multiple pressurizable devices, said establishing is based on
   (i) a number of fluid channels, power channels, or data channels in a cable that connects that pressurizable device to the controller, or
   (ii) a presence of fluid channels, power channels, or data channels in the cable that connects that pressurizable device to the controller.
13. The method of example 10, wherein for each of the multiple pressurizable devices, said establishing is based on an analysis of a wireless communication received from that pressurizable device.
14. A non-transitory medium with instructions stored thereon that, when executed by a processor, cause the processor to perform operations comprising:
   verifying each pressurizable device of multiple pressurizable devices to be fluidically coupled to a controller;
   confirming that each pressurizable device of the multiple pressurizable devices is properly connected to a corresponding one of multiple egress interfaces through which fluid is able to flow;
   for each pressurizable device of the multiple pressurizable devices,
      identifying a programmed pattern for that pressurizable device from among a plurality of programmed patterns; and
      causing one or more chambers of that pressurizable device to be inflated in accordance with the programmed pattern.
15. The non-transitory medium of example 14, wherein the operations further comprise:
   receiving input indicative of a request to initiate a deflation procedure for a given pressurizable device of the multiple pressurizable devices; and
   causing, in response to said receiving, all chambers of the given pressurizable device to be deflated.
16. The non-transitory medium of example 15, wherein all chambers of the given pressurizable device are deflated while other pressurizable devices of the multiple pressurizable devices continue to be inflated in accordance with the corresponding programmed patterns.
17. The non-transitory medium of example 14, wherein the operations further comprise:
   for each pressurizable device of the multiple pressurizable devices,
      receiving input indicative of a request to initiate an inflation procedure; and
   wherein said verifying, said confirming, said identifying, and said causing are performed independently for each pressurizable device of the multiple pressurizable devices in response to said receiving.
18. The non-transitory medium of example 14, wherein said verifying comprises:
   for each pressurizable device of the multiple pressurizable devices,
      ensuring that a programmed pattern associated with a corresponding type of pressurizable device is included in the plurality of programmed patterns.
19. The non-transitory medium of example 14, wherein said confirming comprises:
   for each pressurizable device of the multiple pressurizable devices,
   ensuring that a cable is properly secured to the corresponding one of the multiple egress interfaces by examining a rate at which fluid is flowing therethrough and comparing the rate to the programmed pattern.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification unless those terms are explicitly defined herein. Accordingly, the actual scope of the technology encompasses not only the disclosed embodiments but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description but rather by any claims that issue on an application based hereon. Accordingly, the disclosure of various embodiments is intended to be illustrative, but not limiting, of the scope of the technology as set forth in the following claims.

What is claimed is:

1. A controller comprising:
a structural body that includes
(i) a first egress interface that is fluidically coupled to a first pressurizable device with one or more chambers that, when inflated, cause pressure to be applied to, or relieved from, a first anatomical region of a living body, and
(ii) a second egress interface that is fluidically coupled to a second pressurizable device with one or more chambers that, when inflated, cause pressure to be applied to, or relieved from, a second anatomical region of the living body;
a processor; and
a memory that includes instructions for regulating fluid flow into the first and second pressurizable devices in a controlled manner,
wherein the instructions, when executed by the processor, cause the processor to:
identify a first programmed pattern corresponding to the first pressurizable device,
cause the one or more chambers of the first pressurizable device to be inflated in accordance with the first programmed pattern,
identify a second programmed pattern corresponding to the second pressurizable device, and
cause the one or more chambers of the second pressurizable device to be inflated in accordance with the second programmed pattern.

2. The controller of claim 1, wherein the structural body further includes an ingress interface that is fluidically coupled to a pump that supplies a flow of fluid that is manipulated by the controller to inflate the first and second pressurizable devices in accordance with the first and second programmed patterns, respectively.

3. The controller of claim 1,
wherein the first pressurizable device is a pressure-mitigation apparatus that includes a geometric arrangement of multiple chambers to be situated between the living body and an underlying surface, and
wherein the second pressurizable device is a deep vein thrombosis (DVT) compressor, an intermittent pneumatic compression (IPC) device, or a vital sign monitoring device.

4. The controller of claim 1, wherein the processor is further configured to:
modify the second programmed pattern based on an analysis of the first programmed pattern.

5. The controller of claim 1,
wherein the controller further comprises:
a communication module configured to:
initiate communication with a source that is external to the controller, and
receive, from the source, data associated with the living body; and wherein the processor is further configured to:
modify the first programmed pattern and/or the second programmed pattern based on an analysis of the data.

6. The controller of claim 5, wherein the source is hospital equipment that generates or stores the data.

7. A method performed by a controller that is fluidically connected to multiple pressurizable devices that apply force to, or alleviate force applied to, different anatomical regions of a living body, the method comprising:
receiving input indicative of a request to treat the living body with the multiple pressurizable devices;
identifying multiple programmed patterns for the multiple pressurizable devices; and
causing each of the multiple pressurizable devices to be controllably inflated to varying degrees in accordance with a corresponding one of the multiple programmed patterns.

8. The method of claim 7, wherein said receiving comprises:
for each of the multiple pressurizable devices,
receiving a separate input indicative of an acknowledgment that that pressurizable device is fluidically coupled to the controller.

9. The method of claim 7, wherein the multiple pressurizable devices include at least two different types of pressurizable device.

10. The method of claim 7, further comprising:
establishing a type of pressurizable device for each of the multiple pressurizable devices;
wherein the multiple programmed patterns are identified from among a plurality of programmed patterns based on the types of the multiple pressurizable devices.

11. The method of claim 10, wherein for each of the multiple pressurizable devices, said establishing is based on an analysis of an output produced by a sensor located proximate to a corresponding one of multiple egress interfaces to which the multiple pressurizable devices are fluidically coupled.

12. The method of claim 10, wherein for each of the multiple pressurizable devices, said establishing is based on
(i) a number of fluid channels, power channels, or data channels in a cable that connects that pressurizable device to the controller, or
(ii) a presence of fluid channels, power channels, or data channels in the cable that connects that pressurizable device to the controller.

13. The method of claim 10, wherein for each of the multiple pressurizable devices, said establishing is based on an analysis of a wireless communication received from that pressurizable device.

14. A non-transitory medium with instructions stored thereon that, when executed by a processor, cause the processor to perform operations comprising:
verifying each pressurizable device of multiple pressurizable devices to be fluidically coupled to a controller;
confirming that each pressurizable device of the multiple pressurizable devices is properly connected to a corresponding one of multiple egress interfaces through which fluid is able to flow;
for each pressurizable device of the multiple pressurizable devices,
identifying a programmed pattern for that pressurizable device from among a plurality of programmed patterns; and
causing one or more chambers of that pressurizable device to be inflated in accordance with the programmed pattern.

15. The non-transitory medium of claim 14, wherein the operations further comprise:
receiving input indicative of a request to initiate a deflation procedure for a given pressurizable device of the multiple pressurizable devices; and
causing, in response to said receiving, all chambers of the given pressurizable device to be deflated.

16. The non-transitory medium of claim 15, wherein all chambers of the given pressurizable device are deflated while other pressurizable devices of the multiple pressurizable devices continue to be inflated in accordance with the corresponding programmed patterns.

17. The non-transitory medium of claim 14, wherein the operations further comprise:
for each pressurizable device of the multiple pressurizable devices,
receiving input indicative of a request to initiate an inflation procedure; and
wherein said verifying, said confirming, said identifying, and said causing are performed independently for each pressurizable device of the multiple pressurizable devices in response to said receiving.

18. The non-transitory medium of claim 14, wherein said verifying comprises:
for each pressurizable device of the multiple pressurizable devices,
ensuring that a programmed pattern associated with a corresponding type of pressurizable device is included in the plurality of programmed patterns.

19. The non-transitory medium of claim 14, wherein said confirming comprises:
for each pressurizable device of the multiple pressurizable devices,
ensuring that a cable is properly secured to the corresponding one of the multiple egress interfaces by examining a rate at which fluid is flowing therethrough and comparing the rate to the programmed pattern.
